(19) United States
(12) Patent Application Publication
(10) Pub. No.: US 2012/0089933 A1
(43) Pub. Date: Apr. 12, 2012

(54) CONTENT CONFIGURATION FOR DEVICE PLATFORMS

(75) Inventors: Genevieve Garand, San Francisco, CA (US); Steve Edward Marmon, Mountain View, CA (US); Ralph Zazula, Mountain View, CA (US); Michael Paul Stern, San Francisco, CA (US)

(73) Assignee: Apple Inc., Cupertino, CA (US)

(21) Appl. No.: 13/327,732

(22) Filed: Dec. 15, 2011

Related U.S. Application Data
(63) Continuation-in-part of application No. 13/111,443, filed on May 19, 2011.
Application No. 13/111,443 is a continuation-in-part of application No. 12/881,755, filed on Sep. 14, 2010.
(60) Provisional application No. 61/423,544, filed on Dec. 15, 2010.
(60) Provisional application No. 61/470,181, filed on Mar. 31, 2011.
(60) Provisional application No. 61/557,410, filed on Nov. 8, 2011.

(51) Int. Cl. G06F 3/048

(52) U.S. Cl. 715/765

(57) ABSTRACT

The present technology includes a digital content authoring tool for authoring digital content without the need to understand or access computer code. The present technology further includes creating digital content that can be modified with animation of assets. Each animation can be controlled by an action, and the actions can be tied to a time axis for execution. By relating actions to a time axis, animations based on the actions can be more easily viewed and reviewed. In some embodiments, the system can clear a page of all but a selected asset so that it may be more easily worked with.

### CROSS REFERENCE TO RELATED APPLICATIONS

This application is a continuation-in-part of U.S. patent application Ser. No. 13/111,443, filed on May 19, 2011, entitled CONTENT CONFIGURATION FOR DEVICE PLATFORMS, which claims priority from U.S. provisional patent application No. 61/423,544, filed on Dec. 15, 2010, entitled CONTENT CONFIGURATION FOR DEVICE PLATFORMS and U.S. provisional patent application No. 61/470,181, filed on Mar. 31, 2011, entitled INTERACTIVE MENU ELEMENTS IN A VIRTUAL THREE-DIMENSIONAL SPACE; U.S. patent application Ser. No. 13/111,443 is a continuation-in-part of U.S. patent application Ser. No. 12/881,755, filed on Sep. 14, 2010, entitled CONTENT CONFIGURATION FOR DEVICE PLATFORMS; this application also claims priority from U.S. provisional patent application No. 61/557,410, filed on Nov. 8, 2011, entitled CONTENT CONFIGURATION FOR DEVICE PLATFORMS; all of which are incorporated by reference herein in their entireties for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the patent and trademark office patent files or records, but otherwise reserves all copyright rights whatsoever.

### BACKGROUND

1. Technical Field

The present disclosure relates to an electronic content authoring tool and more specifically to an electronic content authoring tool configured to optimize authored content for one or more intended devices.

2. Introduction

In many instances, computer-programming languages are a hindrance to electronic content creation and, ultimately, delivery to content consumers. Often content creators and designers simply lack the skill and the knowledge to publish their mental creations to share with the world. To begin to bridge this gap, content creators can use some electronic-content-development tools which allow content creators to interact with a graphical user interface to design the content while an electronic-content-development tool puts the computer-programming code in place to represent the electronic content on a user's computer.

One type of such tool is a web page development tool, which allows a user to create webpages with basic features by designing the webpage graphically within the electronic-content-development tool. However, in most instances, such tools can only assist users with basic features. Users wanting customized elements must still have knowledge of one or more computer-programming languages. For example, while some web-content development tools can assist with the creation of basic hyper-text markup language (html) content, these tools have even more limited capabilities to edit cascading style sheet (css) elements. Often variables within the css code must be adjusted directly in the code. Such adjustments require knowledge of computer-programming languages, which again, many content creators lack.

Another challenge in the creation and delivery of electronic content is that the capabilities of user terminals for receiving and displaying electronic content vary greatly. Even if a content creator successfully creates his electronic content, it is unlikely that the content is optimally configured for each device on which the user will view the content. Originally, digital content was created without having to account for device capabilities. The digital content was going to be viewed on a computer or television having a display of at least a certain size, with at least a certain resolution, if not multiple resolutions. Accordingly, it was possible to generate only one version of the electronic content and that version could be expected to be presented properly by the user's device. However, more recently, smaller displays with fixed resolutions, paltry computing resources, inferior browser technologies, and inconsistent network connectivity such as associated with handheld communication devices have made it so that electronic content isn't always adequately displayed on every device for which a user is expected to view it.

Due to such diverse devices having such diverse capabilities, content must now be created not only once, but often several times so that it can be configured for multiple device types. This development has introduced a new barrier to content creation and delivery. To reduce this barrier, an early technology could create mobile versions of web content by converting a web page intended for viewing on a desktop computer or laptop. Such technology is not suitable for most purposes, because the content creator does not get to see the finished product before it is severed to the mobile device. Another problem is that such technology uses a lowest-common denominator approach, wherein the content is converted so that it can be displayed on any mobile device, despite the fact that many mobile devices can display greatly enhanced content.

A further difficulty in creation of electronic content is that assets can frequently overlap each other when developing an application's interface that includes even rudimentary animation. Since the assets can overlap, it is often difficult to work with assets, to view them unobstructed by other objects, and/or to select the assets to work with.

Accordingly, the existing solutions are not adequate to eliminate barriers between content creators and the presentation of high quality electronic content on a variety of platforms.

### SUMMARY

Additional features and advantages of the disclosure will be set forth in the description which follows, and in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology provides a digital content authoring tool for amateur and professional content developers alike, without the need to understand or access any computer code, though that option is available to users skilled in the programming arts. In addition to the ability to create high quality digital content, the authoring tool is further equipped with the ability to manage digital assets and configure them for distribution and viewing on a variety of electronic devices—many of which have diverse hardware capabilities. Accordingly, the presently described technology eliminates many barriers to creating and publishing deliverable electronic content.

The authoring tool receives a collection of assets and other files collectively making up deliverable electronic content. In some instances, the authoring tool provides one or more templates, such as a menu navigation template or one of the pre-defined objects referenced above, as starting points for the creation of electronic content. The templates can include containers configured to receive digital assets so a content creator can modify the templates according to his or her vision. In some embodiments, the authoring tool is configured to receive digital assets by importing those assets into the authoring tools asset library. The assets can be imported through a menu interface or through drag and drop functionality. The assets then may be added to the templates by, for example, dragging the asset onto the desired container on the template or through a menu interface.

In addition to assets, the finished content is created by modifying formatting elements using a widget such as an inspector for modifying Cascading Style Sheet variables and by applying JavaScript elements from a JavaScript library. Custom styles and JavaScript elements can also be created as plug-ins to create highly customized content.

The assets can also be modified with animation. Each animation can be controlled by an action, and the actions can be tied to a time axis for execution. In some embodiments the actions associated with the assets can be visibly displayed in a menu; in some embodiments the menu can be a sidebar though any graphical user interface element for displaying the actions should be considered within the scope of the present technology. The action can be displayed along a visible time axis, however, throughout this description a time axis can refer to both a visual time axis, or time axis maintained by a computing device and used to relate the relative start and stop times of the associated actions. By relating actions to a time axis, animations based on the actions can be more easily viewed and reviewed.

In some embodiments, the system can clear a page of all but a selected asset so that it may be more easily worked with. This can be true in embodiments wherein many assets overlap during the duration of the full time axis needed to portray all animations associated with all assets on a given page. In such embodiments, all assets except for the selected asset can be hidden so that the user can more easily view or work with the selected asset. In some embodiments, not all assets need be hidden, for example, a background asset might remain visible along with the selected asset.

The present technology utilizes an additional layer of abstraction between the graphical elements represented in the graphical user interface and the code that represents them. Specifically, the present technology utilizes a common scheme to identify variables and to modify those variables using a widget such as a graphical user interface inspector rather than having to modify the variables in the underlying code. The present technology additionally utilizes a JavaScript library to implement additional code to perform a variety of features including alternate implementations of an object, event handling behaviors, error handling, etc.

Whether a particular code element (written in HMTL, CSS, JavaScript, etc.) is provided by way of a template within the authoring tool, or is created by the user, the code element conforms to the common scheme within the layer of abstraction. Variable elements can be defined, and identified, either within the code or within a related properties file, which associates the defined variable elements with adjustable user interface elements in an inspector. The type of user interface element, the range of possible values for the defined variable are all identified in the code or properties file accompanying the basic code element. Because of the common scheme, even a custom created element can be adjusted within the user interface because the custom created element also identifies variable elements, the accepted values for the variable elements, and the type of inspector needed to appropriately adjust the variable elements. Further because the extra code defining the ability to modify the variable elements conforms to the common scheme it can easily be identified and removed once it is no longer needed, i.e., after the content is created and ready for upload to a server.

The authoring tool also leverages a JavaScript library running in the background to enhance the code elements, by writing additional code that facilitates the smooth functioning of the objects defined by the code elements, even when those objects are implemented on diverse devices. The JavaScript library instantiates the objects specified by the user using the authoring tool and generates additional code (HTML/CSS/JavaScript) as needed to display the content. This allows the authoring tool to substitute alternate implementations for various situations, such as diverse devices, as needed.

As an example of the functioning of this abstraction layer, a code for a “Button” defines its user-modifiable parameters (size, position, color, etc.), and required parameters that may be managed by the system without the users knowledge (event handling behaviors, error handling, etc.). The application outputs the information required to construct a “Button”, and simulates this in the application user-interface, possibly using the same implementation that will be used at runtime, but there is a possibility that a modified or entirely different implementation will be provided at runtime.

Because the code defining the object meets the common scheme defining user-modifiable objects in the authoring tool, this extra functionality required only at authoring time (user input validation, special handling of authoring environment preview functionality, etc.) is removed when the content is published.

Additionally, the JavaScript library can determine, that graphics processor dependent functionality such as shadows, gradients, reflections are not supported on the device and should be ignored and replaced with less processor intensive UI even if the author specified them.

The finished product can be validated for distribution to one or more known devices that are intended targets for the deliverable content. The publishing tool can determine device criteria associated with each of the devices that are intended to receive the deliverable content from a library of devices or known device criteria. In some embodiments, the device criteria comprises hardware capabilities of a given device. For example, the device criteria can include screen size, resolution, memory, general processing capabilities, graphics processing, etc.

The validation comprising analyzing assets and files for compatibility with the device criteria and, in some instances, expected network connection states, including connection types such as cellular connections or wi-fi, connection reliability, and measured connection speeds.

Once validated, the deliverable content that is compatible with the device criteria can be compiled into a content package for delivery to content consumers using one of the known devices.

In some embodiments, a content delivery server can store a collection of versions of assets, each being compatible with different device or network criteria. In such embodiments, the content delivery server can be configured to select an appropriate version of the asset based on run-time network conditions and the device criteria associated with the device that is requesting the content from the content delivery server.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure, and are not therefore to be considered to be limiting of its scope, the principles herein are described and explained with additional specificity and detail through the use of the accompanying drawings in which:

FIG. 1 illustrates an exemplary graphical-application-flow template screen within a graphical user interface of the authoring tool;

FIG. 2A illustrates the exemplary graphical-application-flow template screen as an initial content creation screen;

FIG. 2B illustrates the result of the action illustrated in FIG. 2A;

FIG. 3 illustrates an exemplary action adding additional pages to the template;

FIG. 4A illustrates exemplary modifications made to the content of a single page;

FIG. 4B illustrates an updated Pre-roll page based on the action illustrated in FIG. 4A;

FIG. 5A illustrates an exemplary action inserting multiple images into a page;

FIG. 5B illustrates the page from FIG. 5A updated with one of the images inserted;

FIG. 5C illustrates the page from FIG. 5A updated with one of the images inserted;

FIG. 6 illustrates an updated graphical-application-flow template screen view;

FIG. 7A illustrates exemplary adjustments to CSS elements using a widget/inspector;

FIG. 7B illustrates the result of the action illustrated in FIG. 7A;

FIG. 8 illustrates an exemplary CSS inspector;

FIG. 9A illustrates an exemplary menu of JavaScript elements;

FIG. 9B illustrates an exemplary menu of JavaScript elements;

FIG. 10A illustrates an exemplary JavaScript elements menu having buttons for editing selected code;

FIG. 10B illustrates editing a JavaScript element;

FIG. 10C illustrates adding a new JavaScript element;

FIG. 11 illustrates a completed application in the graphical site map view;

FIG. 12 illustrates an exemplary asset validation process;

FIG. 13 illustrates an exemplary method of packing the application for upload to a content delivery server;

FIG. 14 illustrates an example system embodiment;

FIG. 15A illustrates an exemplary perspective wall JavaScript element;

FIG. 15B illustrates an exemplary selection action;

FIG. 16 illustrates an exemplary pinwheel menu JavaScript element;

FIG. 17A illustrates an exemplary bare N×M gallery JavaScript element;

FIG. 17B displays an exemplary 3×3 gallery JavaScript element;

FIG. 17C illustrates an exemplary transition effect;

FIG. 17D illustrates an exemplary transition effect;

FIG. 17E illustrates an exemplary completed transition effect;

FIG. 17F illustrates an exemplary interface for adjusting JavaScript variables;

FIG. 17G illustrates an exemplary gallery having various variables adjusted with an inspector;

FIG. 18 illustrates an exemplary page of content authored by the electronic content authoring tool;

FIG. 19 illustrates an exemplary menu of potential actions for modifying content;

FIG. 20 illustrates an exemplary interface for introducing actions;

FIG. 21a and FIG. 21b collectively illustrate a drop in action being associated with graphic 1102;

FIG. 22 illustrates a second exemplary action being associated with graphic 1102;

FIG. 23a and FIG. 23b illustrate an exemplary action set;

FIG. 24 illustrates a preview of the action set 1130 being used to cause graphic 1102 appearing into page 1100;

FIG. 25 illustrates an exemplary action set;

FIG. 26 illustrates an exemplary preview slider embodiment;

FIG. 27a and FIG. 27b illustrate how the present technology can be used to handle overlapping actions;

FIG. 28 illustrates of an over crowded page of overlapping assets;

FIG. 29 illustrates an exemplary action that starts on a user action;

FIG. 30 illustrates an exemplary simulation embodiment;

FIG. 31a and FIG. 31b illustrate a banner that can be used to launch an application in portrait and landscape views, respectively;

FIG. 33 illustrates an edited landscape banner;

FIG. 34a and FIG. 34b illustrate an exemplary multi-image display;

FIG. 35 illustrates an exemplary templates menu embodiment;

FIG. 36 illustrates an exemplary purchase interface template;

FIG. 37 illustrates a customized purchase interface; and

FIG. 38 illustrates further customization that can be available for the purchase interface.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art to eliminate or reduce barriers between content creators and presenting their content to content-consumers.

In some embodiments, the present technology relates to a computer-implemented application for aiding in the creation of electronic content. In one aspect the present technology aids a content developer in creating a multimedia application or web-based application, though it is not limited to such uses.

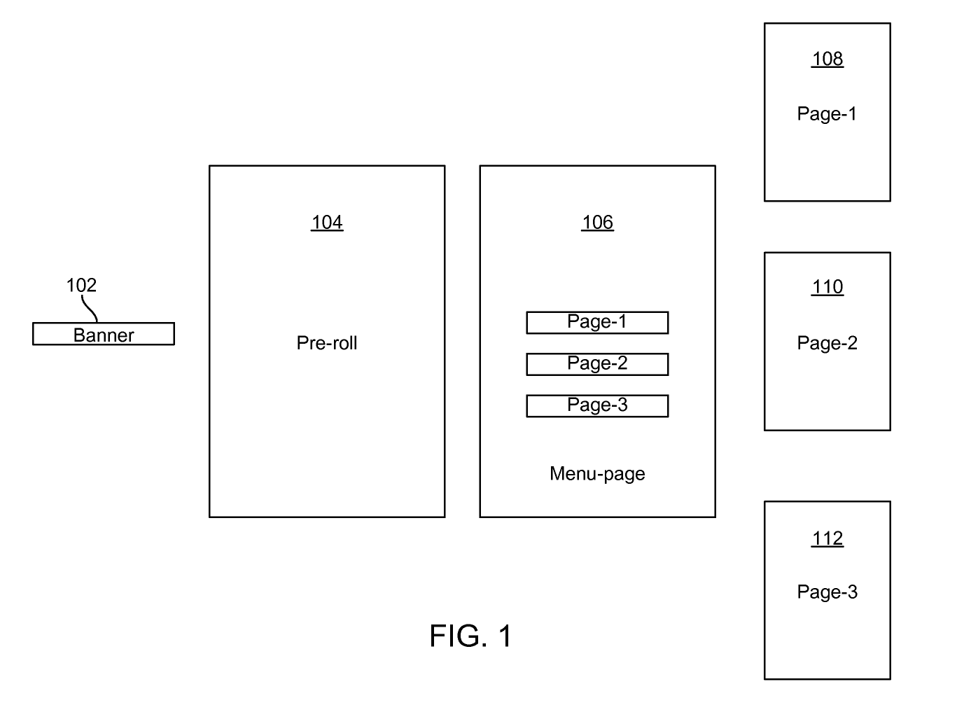

FIG. 1 illustrates a graphical-application-flow template screen within a graphical user interface of the authoring tool. This screen illustrates a general layout of a typical application and is the starting point of the authoring tool. The typical application can progress in layers moving from left to right.

For example, banner 102 is often the first part of the application presented to content consumer. In some embodiments, the banner can be an image, video, or text that is presented to a content consumer, sometimes within other content. In such instances, the banner is similar to a banner advertisements commonly encountered on the Internet. In some embodiments, the banner is more akin to an icon on a desktop.

In either analogous situation (a banner advertisement or an icon) a content consumer can interact with the banner 102, often in the form of a click or selection action, which progresses the content into its next screen, the pre-roll 104. The pre-roll screen can be as simple as an icon indicating that the full content is loading, or more involved, such as a progress base, title page, or a movie.

After the pre-roll screen has completed, the user is presented with the menu-page 106. The menu page is analogous to home page on an Internet website, or a title menu commonly encountered in a movie on a digital video disk (DVD). The menu-page 106, links to all or most other subsequent pages of the application. As an example, menu-page 106 links to subsequent pages, Page-1 108, Page-2 110, and Page-3 112, which each contain their own content.

While the template illustrated in FIG. 1 is one example of a potential application template, other templates may be available. In some embodiments the templates can be modifiable. For example, one or more additional screens can be added, deleted, repeated, or otherwise modified as seen fit by the content-creator. However, in some embodiments the template is not modifiable by the user. In some embodiments portions of the template are modifiable while others are not. A modifiable template, for example, may include containers configured to accept assets. For example, the banner and menu pages can be required, and/or the flow of certain pages (banner->preroll->menu) is fixed.

A content-creator can add assets to the pages to easily fill out their application. An asset can be any file containing digital content. The content-creator can import the content-creator's assets into the authoring tool by dragging a collection of assets or a directory containing assets into an assets menu (illustrated in subsequent figures), or can import the assets using menu options, or by any other known mechanism. The asset may then be added to the desired container in the template. This may be accomplished in a number of ways, including dragging the asset onto the container or through a menu interface.

In some instances, one or more assets can be interrelated. In some embodiments, the content creation application can also detect those relationships that can be useful later. For example, if a movie is imported at the same time as its poster frame, the authoring tool can associate the poster frame with the movie. The simplest example of how this can be executed is anytime a movie file is imported with a single image, the authoring tool can assume the that the image is the movie poster frame and create that association in the meta data of those respective files.

The poster frame can be an image in JPEG format with dimensions that match those of the video player that will be used to play the movie. It is also desirable to name the image file according to a pre-defined naming convention so that the authoring tool can identify and associate the poster with the appropriate video. This is especially useful when more than one other asset is imported along with the poster frame.

In some instances, when a specific asset is imported, the authoring tool can recognize that another related asset is needed and automatically create the asset. Using a movie file as an example, if the movie file is imported without a poster frame, the authoring tool can search the movie file for its poster frame and extract the image. If the authoring tool cannot find the poster frame within the video file, it can automatically use the first frame, or first non-blank frame, as the poster frame. In another example, the authoring tool can require multiple different encoding ratios or bitstreams for a movie depending on the device that the content is intended to be viewed on and its current connection speed. In such instances, the authoring tool can compress the movie file according to the specifications needed for that particular device, anticipated network bandwidth, or several devices and network combinations. Analogous examples can also be made with music bitrates, or aspect ratios and bits-per-pixel (BPP) for images.

As will be addressed in the following figures, assets can be added to the page templates by dragging the asset from an asset menu and dropped onto a container on the page templates, by using an insert asset menu option, or by any other known mechanism for inserting an object. In some embodiments, containers on different pages, or on certain locations on a page, can only accept certain types of assets. While in some embodiments, containers on different pages or locations on a page can accept any type of asset, and these pages will configure themselves to be compatible with an inserted asset. Containers, for example, can be a portion of a webpage or the entire background.

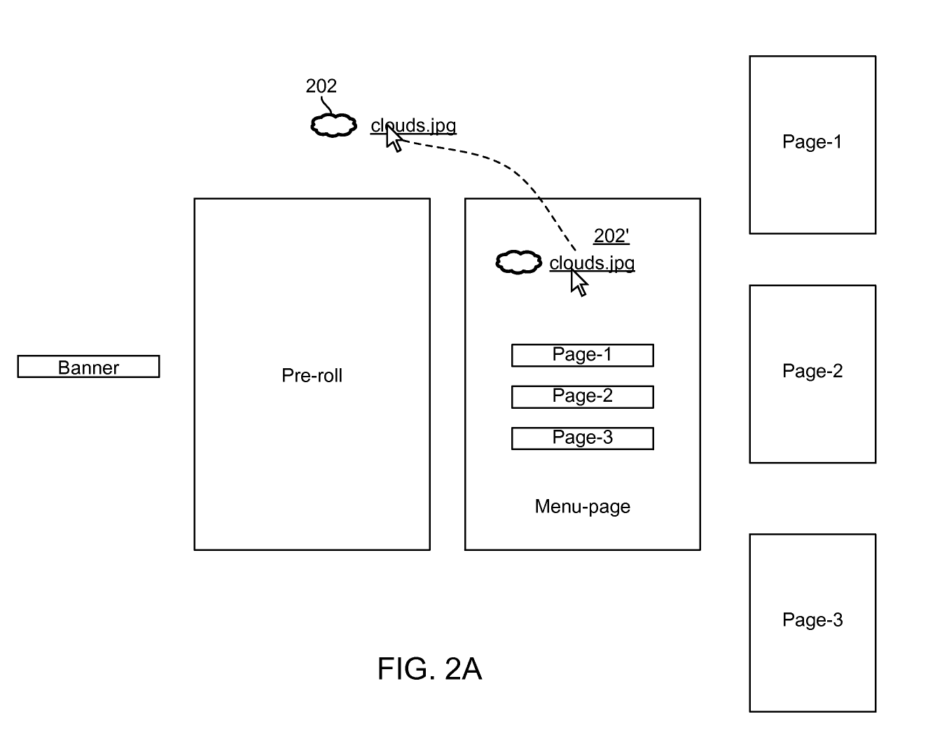

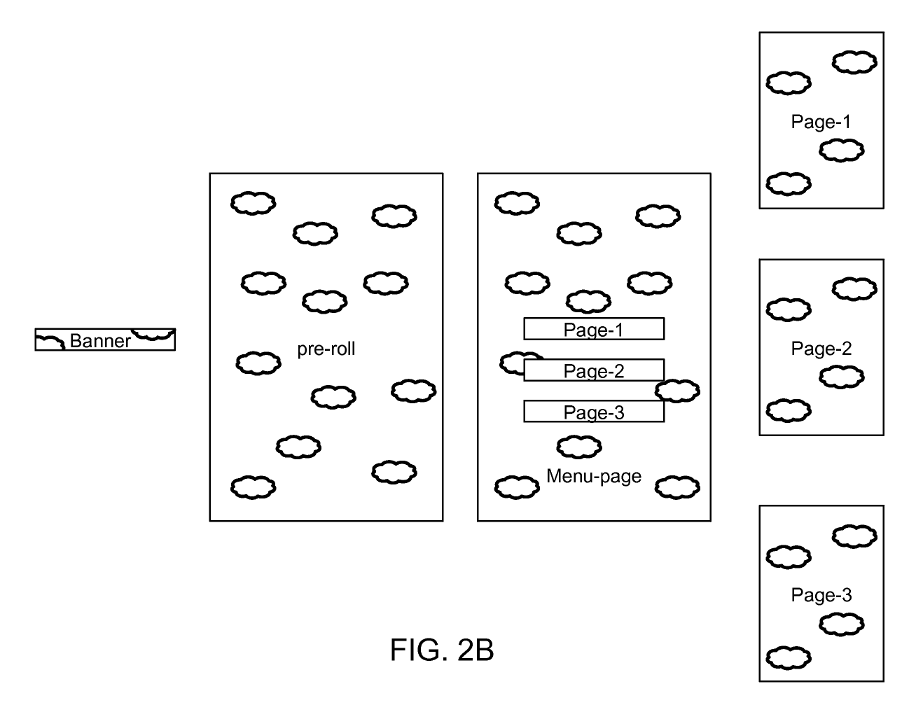

As addressed above, in addition to being a graphical-application-flow template screen, the screen illustrated in FIG. 1 is also able to receive content. FIG. 2A illustrates the graphical-application-flow template screen as an initial content creation screen. In FIG. 2A, the content-creator has selected an asset, a clouds.jpg image 202 and drags the image onto the menu page as indicated by 202′. FIG. 2B illustrates the result of the action illustrated in FIG. 2A, wherein the clouds.jpg image has been applied to the entire template. Each page in the graphical-application-flow template now has the clouds.jpg image as a background image.

When a modification is made to one screen in this graphical-application-flow template screen view, showing each of the screens within the application, the same modification is made to each of the other screens, as appropriate. As in the example illustrated in FIG. 2A and FIG. 2B, since the background of the Menu-page was modified, the background of all of the screens within the application were also modified. Other modifications in one screen that can be translated to the other screens include, but are not limited to, adjustments to fonts and colors, or relationships between Page-1 and the menu item for Page-1. However, not all modifications made in this view make sense to translate to the other screens. A modification to the Pre-roll might not make sense to add to the other pages. For example, adding a video to the pre-roll screen is one such modification that would not be applied to the other screens.

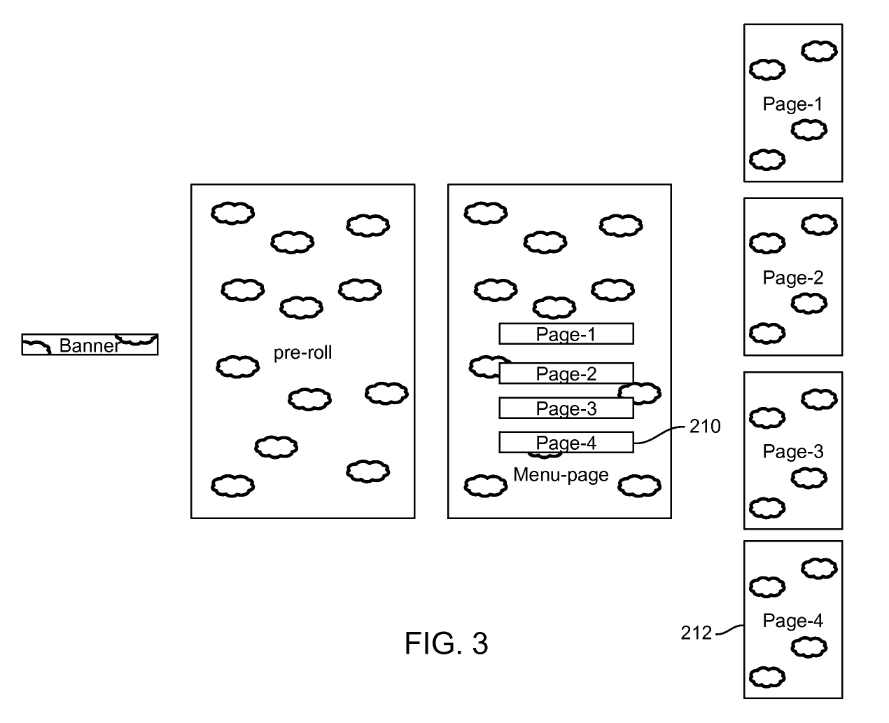

FIG. 3 illustrates that additional pages can be added to the template. When a new page is added, such as Page-4 212, the Menu-page updates to include the page in the menu as illustrated by menu item 210. Additionally, any template-wide characteristic, such as the cloud background, is automatically applied to the new page. Other changes can also be propagated automatically, as is discussed throughout. For example, when a page is renamed the corresponding menu element can also be retitled.

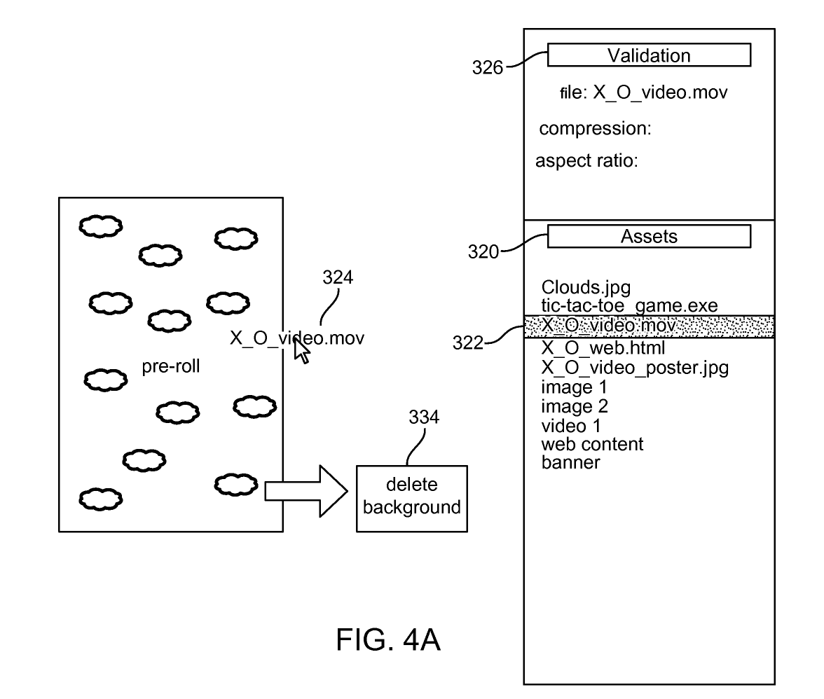

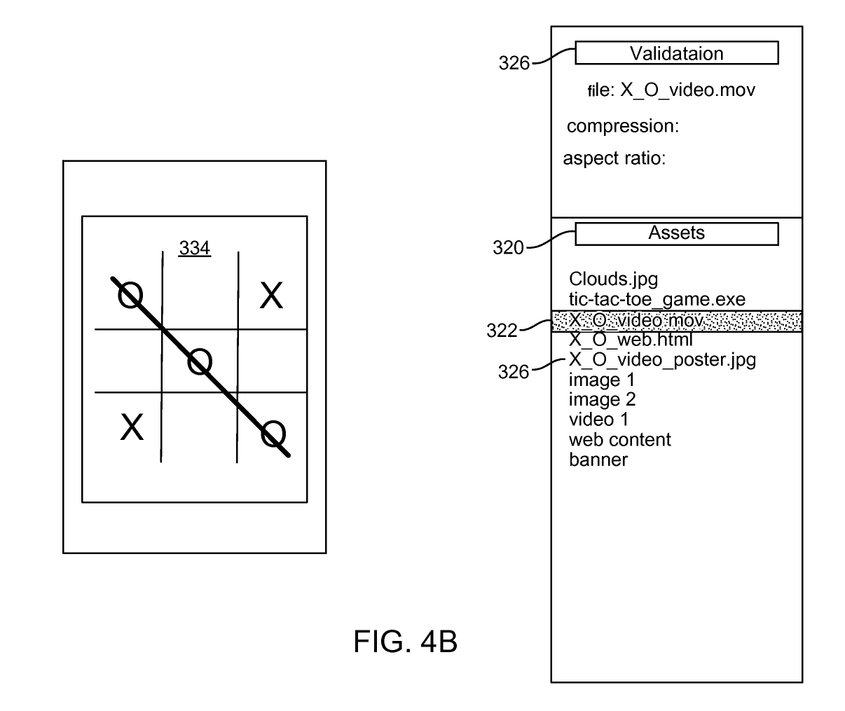

FIG. 4A illustrates modifications made to the content of a single page. 334 illustrates that commonly applied elements can be modified or removed on the individual pages of the application. Specifically 334 illustrates that the cloud background that was automatically applied to the pre-roll page in the graphical-application-flow template screen, can be removed from this page, individually, in this screen specific view.

Also illustrated in FIG. 4A is an “Assets” menu 320. This menu graphically lists each of the assets that are available for inclusion into the program. These assets include text, videos, web content, images, etc. that the user has created and made available to the authoring tool.

Also illustrated is a Validation tool 326 to validate selected assets. In the illustration, X_O_video.mov 322 is selected and the validation tool can illustrate the particular characteristics of the file and whether those characteristics are compatible with one or more device types for which the content is intended to be displayed. Validation will be discussed in more detail below.

FIG. 4A also illustrates that asset 322 is being dragged on and dropped in 324 on the Pre-roll screen, thus inserting the asset onto the Pre-roll page.

FIG. 4B illustrates the updated Pre-roll page. The cloud background has been deleted and the X_O_video.mov has been inserted on the Pre-roll pages and its poster image (asset 326) is displayed 334.

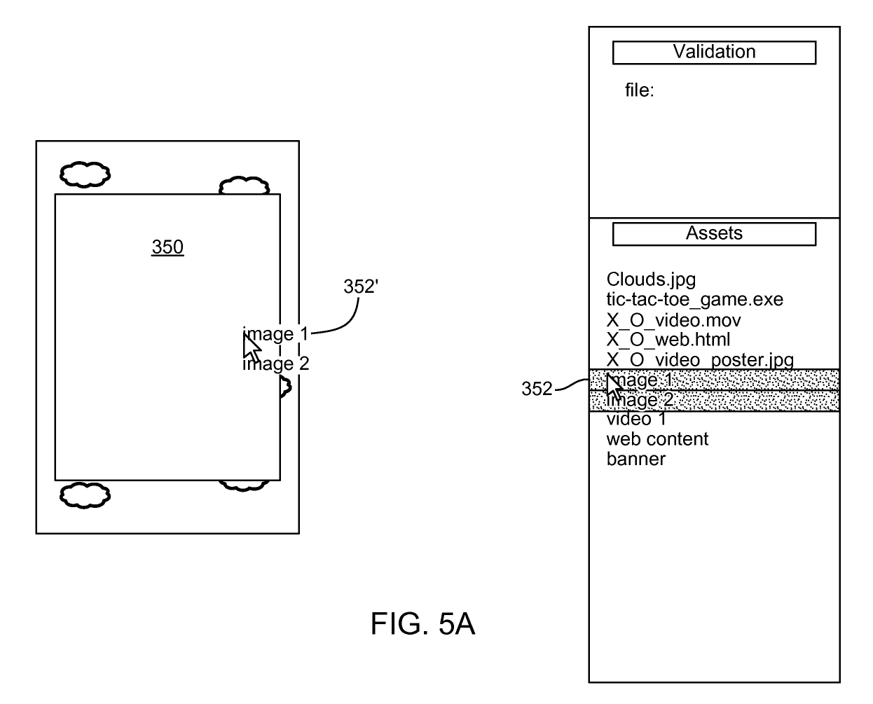

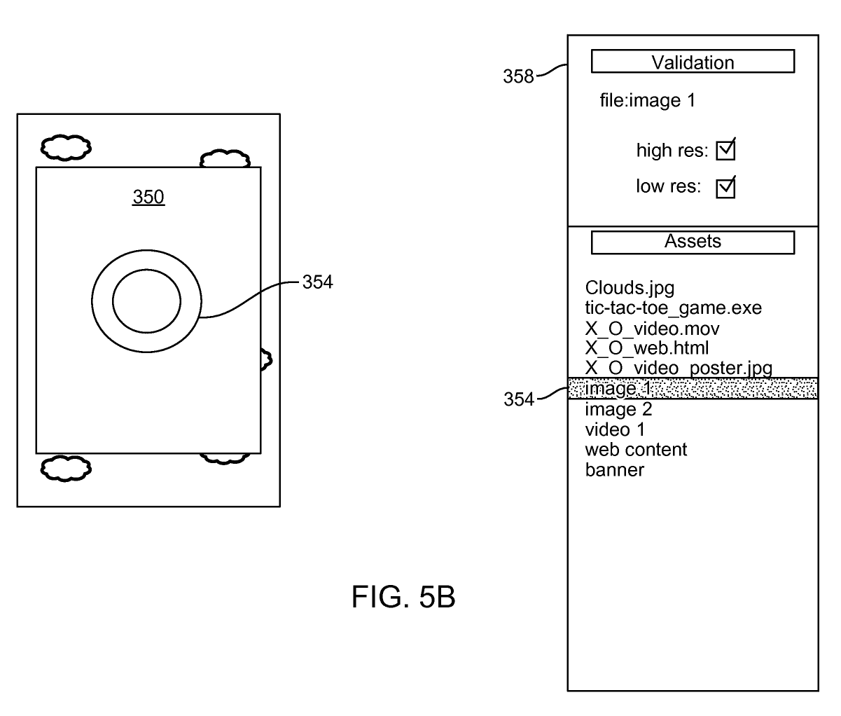

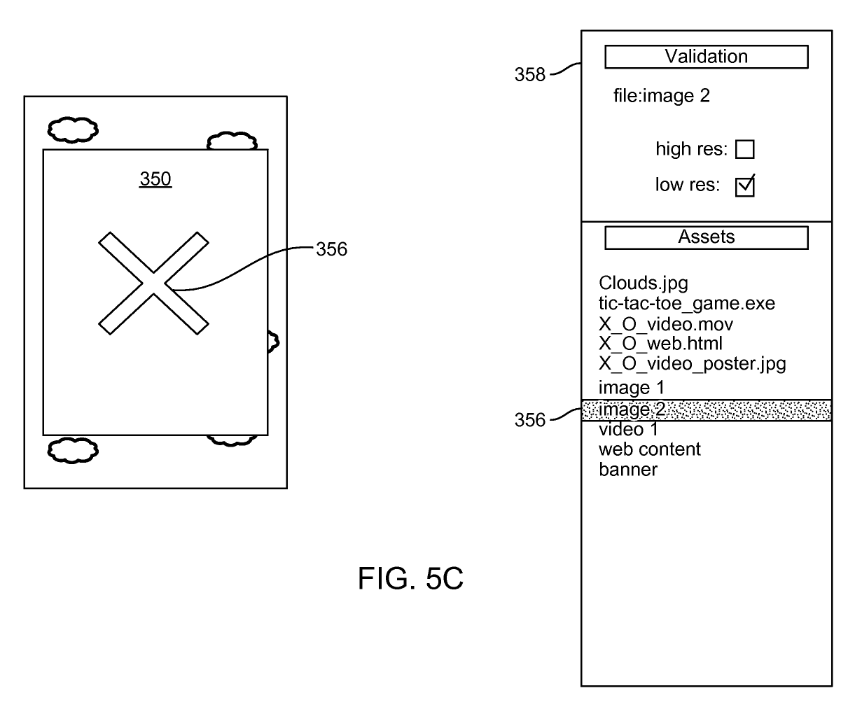

FIG. 5A illustrates inserting multiple images into a page. Specifically Page-1 is shown having an object container, or placeholder 350. A user has selected two images 352, image 1 and image 2 and has dragged and dropped the images 352′ into placeholder 350.

FIG. 5B illustrates the updated page having both images of the images inserted, but only displaying the first image. Specifically, container 350 is shown with image 354 displayed within it. Additionally, the validation tool 358 is shown validating that the image 354 is available in the required resolutions (high and low). When image 1 was imported, the user imported two images—the high-resolution image and the low-resolution image. However, for simplicity of use, the authoring tool recognizes that the images are two different versions of the same asset and displays a common asset in the asset library. This allows the user to manipulate a single object (e.g., dragging to the canvas) to make the assignment and the authoring tools work behind the scenes to grab the appropriate version based on the current display mode. In some embodiments, the assets conform to a naming convention to allow the authoring tool to associate two different versions of the assets. For example, a user can create image_{—}1@2x.jpg and image_{—}1.jpg files. When imported, we associate these two as the 2x and 1x versions, respectively, for an asset named image_{—}1.jpg. In the user interface the authoring tool would only display one entry, but flags it to indicate it is a multi-resolution asset, for example: image_{—}1.jpg [1x] [2x]. The availability of both required assets is indicated in the real time validation tool 358.

FIG. 5C illustrates the updated page having both of the images inserted, but only displaying the second image. Specifically, container 350 is illustrated with image 356 displayed within it. In this instance, the content creator has chosen to navigate to the second image within the design application. It can be especially useful to show the exact assets and user interface that the end user device will see at run time so that the content designer can adjust the content as needed without having to switch from a design application to a test application. Additionally, validation tool 358 indicates that image 2 356, is only available in low resolution and that a high resolution image is still needed. As can be inferred from the discussion above, Image_{—}2 was imported without a corresponding high-resolution version. The real-time validation tool 358 can inform the content developer that the high-resolution asset is needed.

While in some embodiments it is possible for the authoring program to make missing assets from available counterparts, it is not desirable to create a higher resolution image from a lower resolution image. However, the authoring tool may be able to create a lower resolution from a properly sized higher resolution image. In either case, the application will indicate which assets were provided by the user and which were automatically generated, so that the user can review these proposed auto-generated assets and decide if he/she wants to use them or provide his/her own.

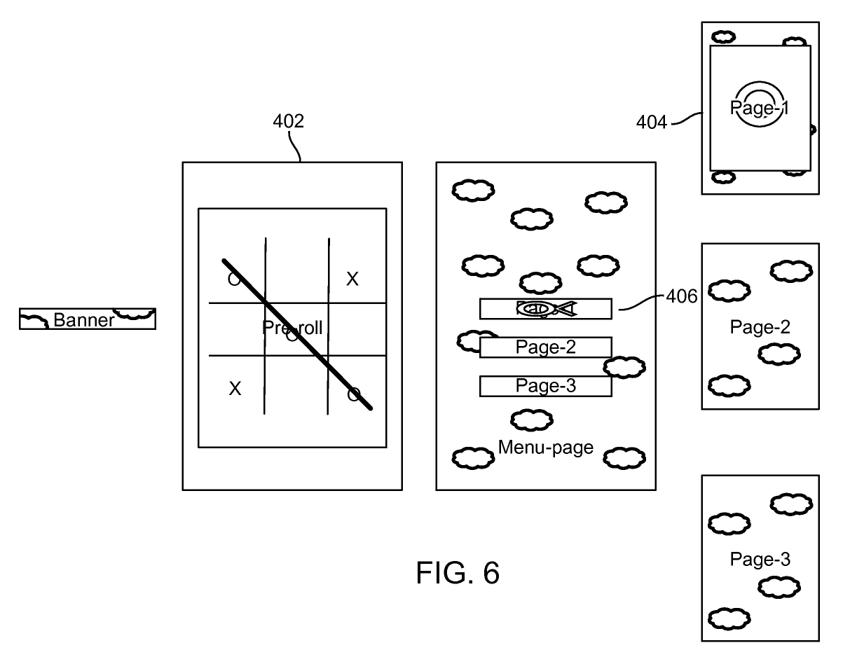

FIG. 6 illustrates an updated graphical-application-flow template screen view. The pre-roll screen 402 is illustrated with the update made to that page in FIG. 4A. Notably, the background has been deleted and a movie has been inserted. The movies poster frame is illustrated. Additionally, Page-1 404 is illustrated with one of the images inserted into that page in FIG. 5A. The menu page has also updated to match the changes made to Page-1. Link 406 now contains an icon made from a blend of the images inserted in Page-1. The link image could have been an asset that was associated with the figures, an asset that was separately inserted, or, in some embodiments, it can be automatically generated.

As addressed above, simply helping content developers get their content into an application is just one step in the process. An authoring tool needs to also allow content creators to adjust their creations and the functionality of the application within the user interface of the authoring tool.

This principle of the present technology can be understood by exploring a web-based application or a collection of web-browser-compatible content resembling the application. Web-browser-compatible content often has several different components of code. For example, Hyper-text-markup language code (HTML) can define the basic format and content, JavaScript can define the movement of objects defined by the HMTL code, and cascade style sheet (CSS) elements can adjust the format or style of the formatting elements defined in the HTML code. (It is understood that other code types and objects are also web-browser-compatible content. The present technology should not be considered limited to the code languages described herein.)

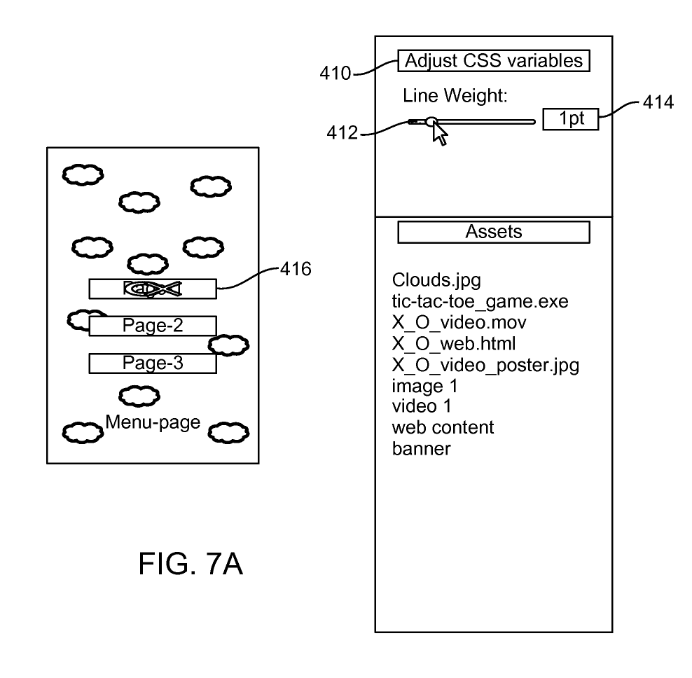

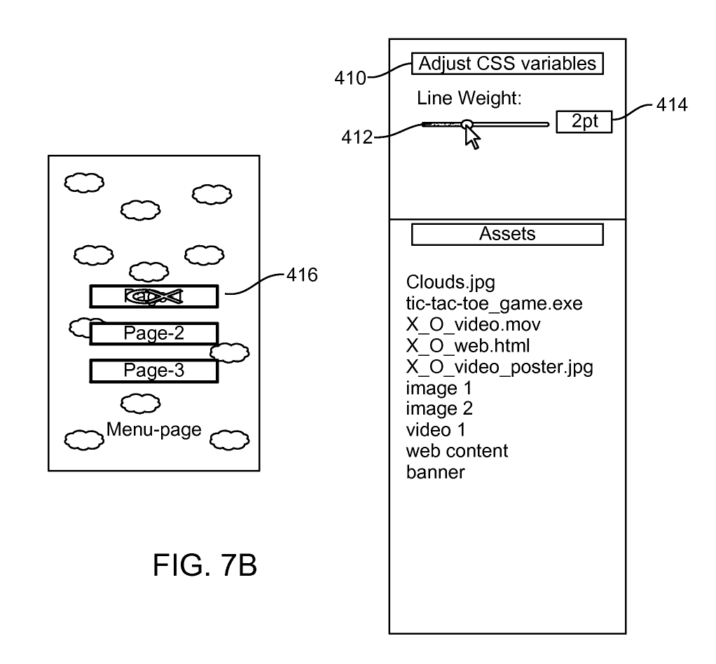

In such an application using HTML code, JavaScript and CSS, it is not sufficient to merely allow a content creator to enter content in HTML. The content creator needs to be able to make refined adjustments to make high quality content. As illustrated in FIG. 7A and FIG. 7B such adjustments can be made using a widget to adjust CSS elements. A CSS widget or inspector 410 is displayed for adjusting a line weight by a slider 412 user interface element or by entering a value in a text box 414. In the illustrated example, the content creator is adjusting the line weight used to display the box 416. FIG. 7B illustrates that the line weight has been adjusted by moving the slider to a 2 pt line weight. The slider and text box have adjusted corresponding to this change.

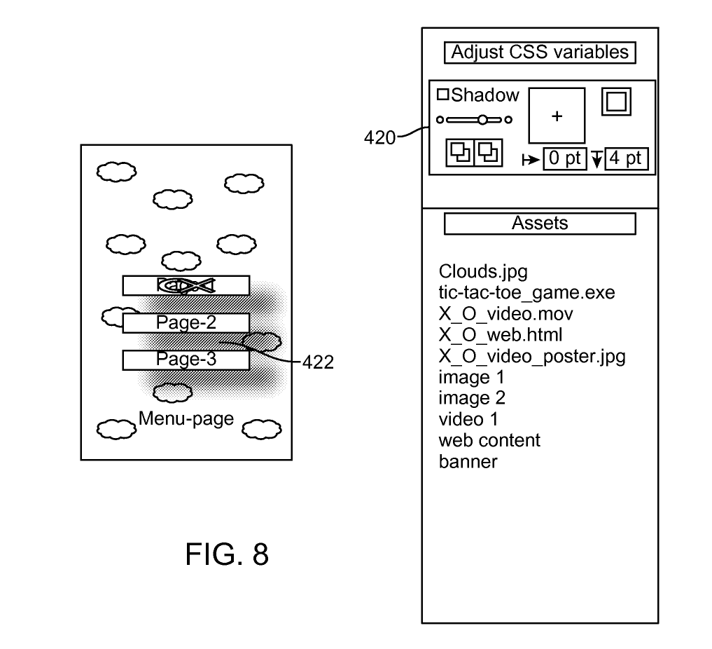

FIG. 8 illustrates another CSS inspector. Specifically, a shadow inspector 420 can be manipulated to adjust the direction, weight, offset and other attributes of a shadow, such as shadow 422.

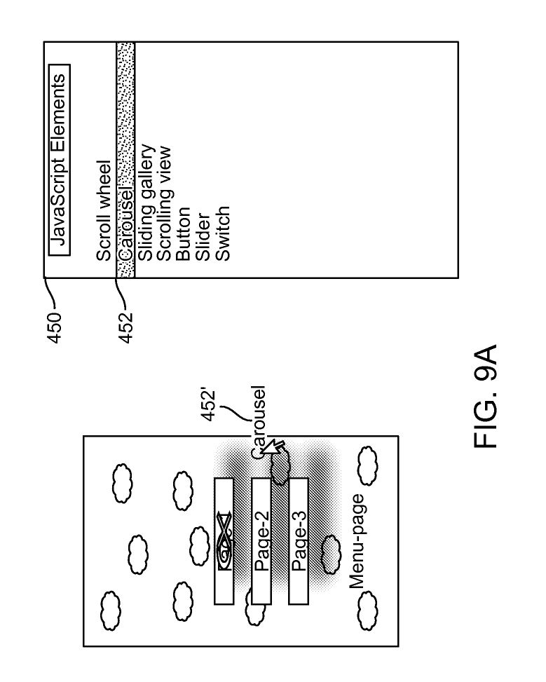

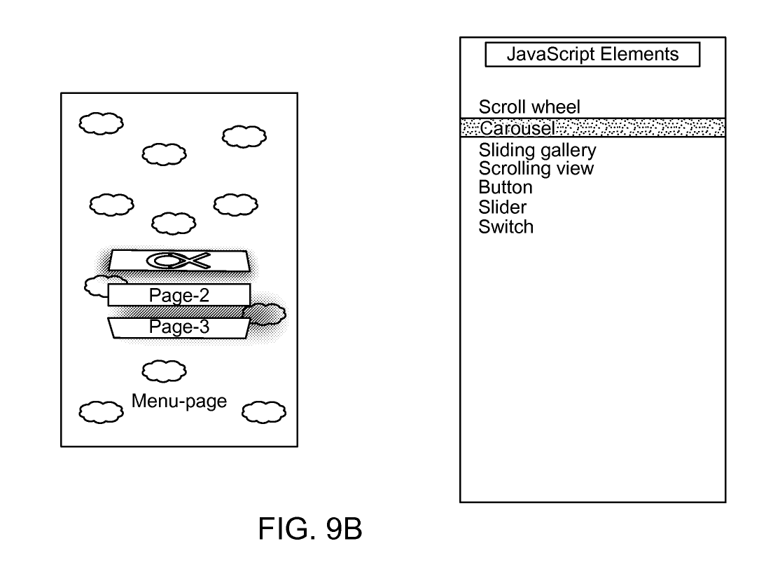

FIG. 9A and FIG. 9B illustrates a menu of JavaScript elements. Again, it is desirable to allow content-creators to introduce and adjust their content as much as possible within the user interface. As such, the present technology makes use of a JavaScript library of JavaScript elements such as those presented in the JavaScript menu 450. The JavaScript library can include primitive elements such as buttons, sliders, and switches that are used standalone; and more complex “composite” elements such as carousels, scroll views, and lists that have multiple “cells” that may contain primitives and other composite elements. It should be appreciated that the other common JavaScript elements not shown here can also be included in the JavaScript library.

As illustrated, a user has selected the Carousel element 452 and dragged and dropped the Carousel element 452′ onto the menu page. Such action transforms the listing of links on the menu page into a rotatable 3-D Carousel as illustrated in FIG. 9B.

In some embodiments, widgets or inspectors can also be provided for adjusting known variables within the JavaScript code. For example, in the case of the rotatable 3-D Carousel, the shape of the menu items, the speed and direction of rotation, spacing, number of containers on the menu can be adjusted using an inspector. Additionally, the number of containers can be increased by just dragging additional assets onto the carousel.

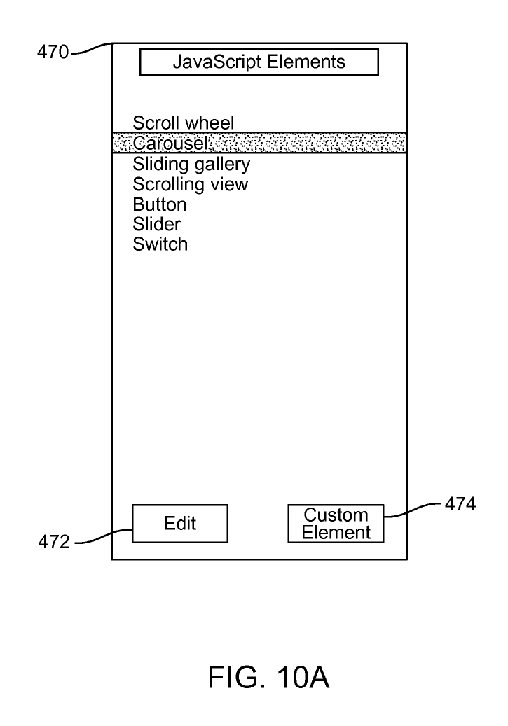

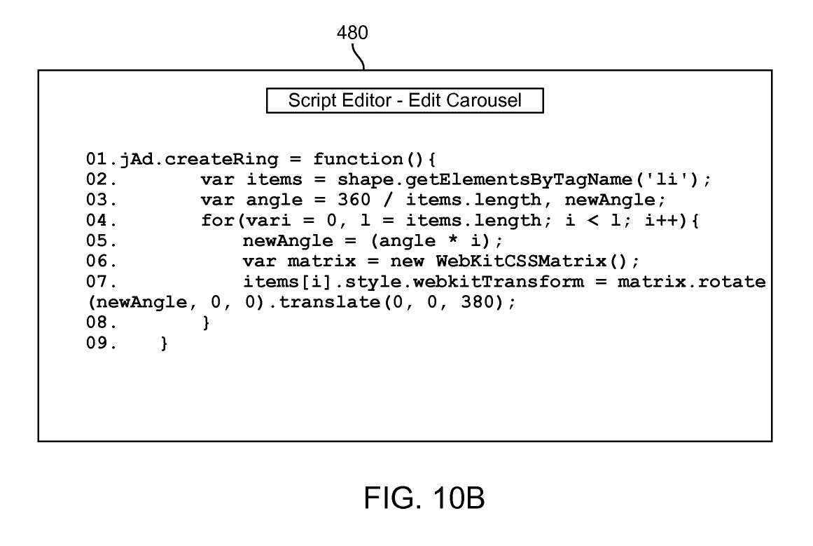

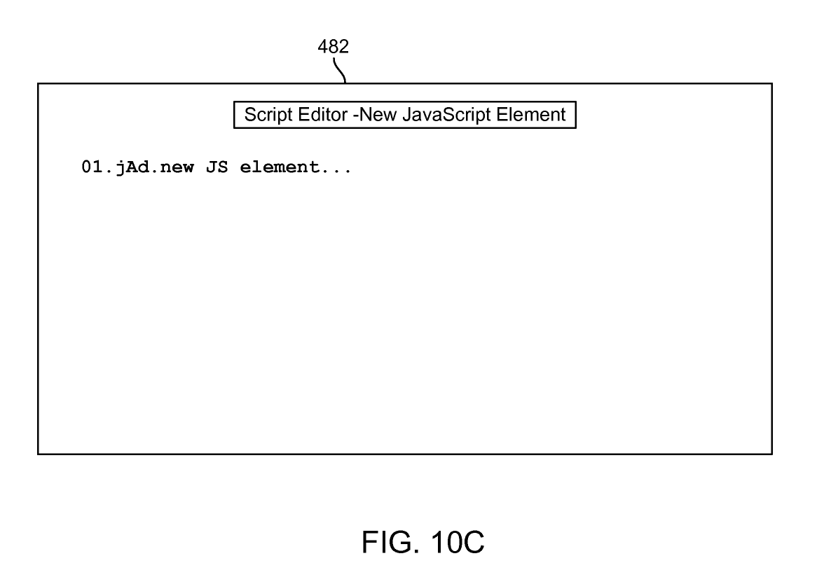

While many adjustments can be made in the form of user-interface elements to allow users with little or no experience working with code to create high quality content, the present technology also facilitates and allows an advanced user to add new elements or customize new elements. FIG. 10A, FIG. 10B, and FIG. 10C illustrate that JavaScript elements can be edited at the code level or created. FIG. 10A shows a JavaScript elements menu 470 having buttons for editing selected code 472 or for creating a custom JavaScript element 474. FIG. 10B illustrates editing the Carousel JavaScript element 480.

FIG. 10C illustrates adding a new JavaScript element 482. When a new JavaScript element is introduced, the user can also define which elements of the JavaScript element should be interactive or modifiable using an inspector. The user can create a definitions or properties file to accompany the new JavaScript element that defines variable elements within the JavaScript code and a range of available parameters. The properties file can also define which inspector elements need to be provided, e.g., a slider, pull down menu, buttons, etc.

When a content-creator modifies a JavaScript element or adds a new JavaScript element, that element can be saved for later use in other projects. Accordingly, a content-creator can make highly customized content and reuse design elements in later projects as they see fit.

In such instances, wherein a content developer adjusts or creates his/her own code, the present technology can also include a debugger application to ensure that the code is operational.

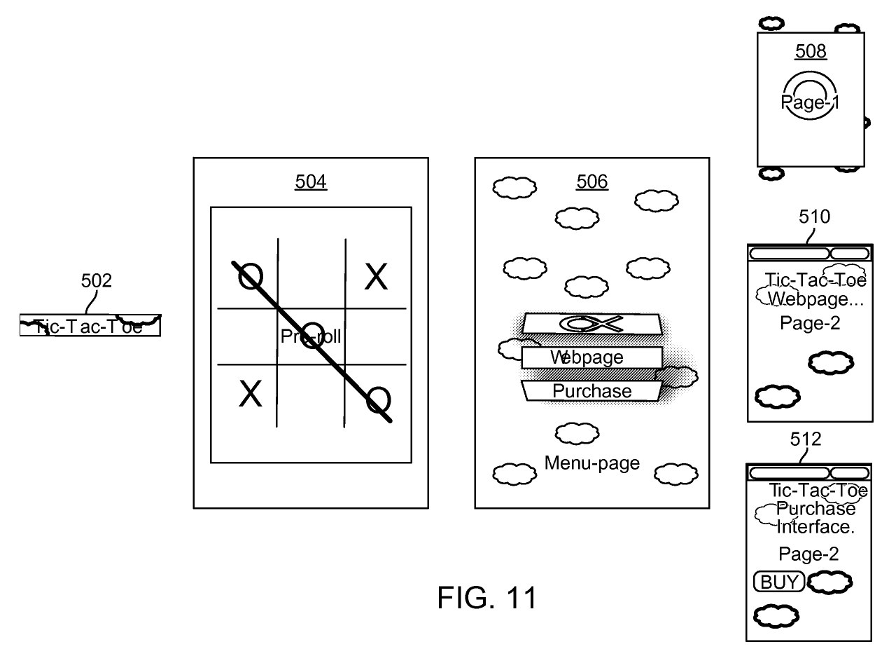

FIG. 11 illustrates a completed application in the graphical site map view. The banner image 502 is illustrated having the clouds background and the Tic-Tac-Toe title of the application. If a user clicks on or interacts with the banner, the application will launch and proceed to the Pre-roll page 504. The Pre-roll page 504 is illustrated without the clouds background and containing the Tic-Tac-Toe movie. Presently, the poster frame image is displayed, though, if a user interacts with the image, or a determined period of time has lapsed (such as the time to load or buffer the movie) the movie will begin to play. After the completion of the movie, the application progresses to the Menu-page 506. The Menu-page 506 includes the rotatable 3-D Carousel having links to the images Page-1 508, a Webpage, Page-2 510, and a Purchase Interface, Page-3 512. Clicking on any menu link will take the user to the respective page to view the associated content. Scrolling the rotatable 3-D Carousel will rotate the carousel to the next menu item.

Having a complete application is only one step in successfully publishing electronic content and presenting it to users. As addressed above, today's devices come in many different sizes and have different display and processing capabilities. Accordingly, content often needs to be configured or optimized for different devices. Such a step requires knowledge of the capabilities of each device. Additionally, different users connect to the Internet in various ways and sometimes multiple ways, even in the same usage session. Accordingly, getting content to users requires taking into account the variance in the different network technologies too.

Even if a content developer did understand the varying capabilities of the different device and network connections and further knew the different specifications required to optimize content for delivery and presentation on a content consumer's device, creating optimized packages of each application would be a time consuming process.

Accordingly, the present technology can automatically perform this function. Before creating a content package optimized for a particular device, the assets within the application must have their compatibility with a device's specifications and common network types validated. The content distribution server might also impose certain requirements, and these too can be considered in the validation process.

While some validation can be conducted during the creation of the application (the validation widget in FIGS. 4 and 5 can alert the user that assets having different characteristics are needed) a validation process can also be included to ensure the application is ready to be packaged for distribution.

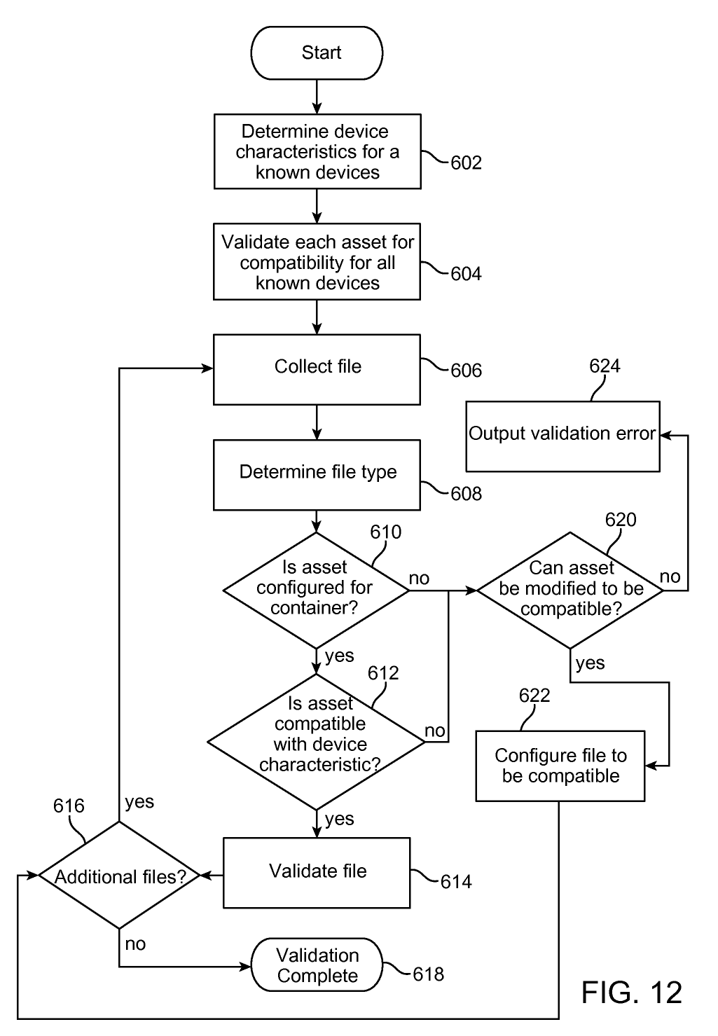

FIG. 12 illustrates an exemplary asset validation process. The authoring tool can be endowed with knowledge of all known devices, groups of devices, connection types, and content distribution servers for which the content might be distributed. Alternatively, the user can input the device characteristics. The authoring tool may also learn of additional device configurations through communication with a server. Regardless of how learned, the authoring tool can determine device characteristics for all known devices and potential connection types 602. In some embodiments the user might select a subset of the known devices and connection types if the content is not intended for distribution outside of those devices.

Based on the determined characteristics of the known devices and connection types, each asset within the content is validated 604 for meeting the relevant characteristics. For example, images might need to be validated for appropriate bpp, and aspect ratio, while videos might require need to be validated for frame rates, size, aspect ratios, compression, encoding type, etc. The validation can occur as follows: A first asset is collected from the finished application 606 and the validation module determines the type of file 608 (image, banner, text, video, etc.).

Based on the asset characteristics the validation module can determine firstly if the asset is appropriate for its use in the application. As addressed above, certain assets are not universally appropriate for all screens in the application. If an incorrectly configured asset was inserted in a container such is determined at 610. An incorrectly configured asset can be one that is not in the appropriate aspect ratio for the frame or one that is not available in the multiple configurations for which the object is expected to be required when viewed by users on their devices. For example, an asset in the banner page might be required to be provided in a landscape and a portrait configuration.

If the validation routine determines that the asset is configured for its container, the validation algorithm next determines 612 if the asset is compatible with the characteristics of each device on which it might be displayed. For example, the routine determines if the asset is available in all aspect ratios and pixel densities and file sizes that might be required to serve and display the content on the devices.

If the validation routine determines the asset is compatible with each device, the asset validation is complete 614 and the routine determines if there are additional assets requiring validation 616. If not the validation routine is complete and it terminates 618.

If, however, there are additional files to validate, the routine will begin a new collecting of the next asset 606.

Returning to 610 wherein the asset is analyzed for configuration with its container and 612 wherein the asset is analyzed for configuration with device characteristics, if either analysis determines that the asset is not properly configured for the container or device characteristics, respectively, the routine proceeds to determine if the asset can be modified automatically at 620. Assets can be modified automatically where it might require resizing, encoding, or generation of a lower quality asset. If the asset can be modified to be compatible then the routine proceeds to 622 and the asset is appropriately configured. In some embodiments the user is given the option of whether the routine should perform the modification. If the asset is not determined to be modifiable at 620, the routine outputs a validation error and requests user involvement to fix the problem 624.

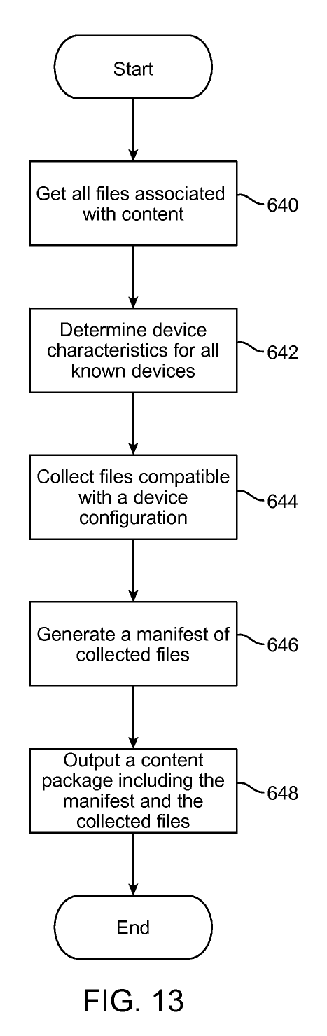

Once all assets have been verified the application must be packaged for upload and use by a content delivery server. FIG. 13 illustrates an exemplary method of packing the application for upload to the content delivery server. At 640 the routine gathers all assets associated with the application. At 642 the routine determines device configurations and collects the assets that are compatible with one of the device configurations 644 and generates a manifest of collected files 646. The manifest is a descriptive file identifying each of the assets and their relationship to the main application file. Finally, a content package is output including all assets and the manifest configured for the specified device configuration 648.

The routine illustrated in FIG. 13 can be repeated for each device configuration desired. Alternative, the manifest file can designate different assets for different device configurations. Regardless of the method of creating the package for upload to the server, the output should be according to the server's requirements. If the server is configured to accept one application configured for each device than the method of FIG. 13 is followed. If the server is configured to accept a manifest describing all assets and the appropriate situation for employing the assets then such a package can be created.

Before the package can be uploaded to a content delivery server, the application must first be tested. This step can be especially important for professional content creators. Since content creation is their livelihood they need to view each screen of the application as it will be displayed on the individual devices. The importance of this step is even more important when some assets have been modified by the authoring tool and therefore may not have been viewed by the content creator.

The application can be tested in each format (device configuration) for which it is expected to run. Only after the application has been tested for a given device configuration should it be approved to be uploaded to the server for distribution to content consumers.

In some embodiments, the above-described technology is an HTML5 authoring tool which is useful for, among other things, creating mobile advertisements. It embodies a number of key processes for authoring, testing and publishing advertisements to the mobile advertisement network. However, many of the activities described herein are applicable to HTML5 authoring in general.

In one aspect, the present technology is used for authoring of interactive HTML5 content for the web, for advertising, for inclusion in non-web content delivery applications such as, a book reader, a magazine, an interactive menu system for accessing video content whether viewed on a traditional computer, mobile devices, tablets, set-top boxes, or other devices.

The first step in creating an advertisement is defining the structure and flow of an ad. This can be defined manually, by adding and ordering pages using a graphical site map, or automatically, by selecting a pre-built project template. The project template defines the initial structure of the ad, for example: a banner page, leading to a splash page that cycles while content is loaded, leading to a “pre-roll” video page that plays an introductory video, leading to a menu page with navigation options to one or more content pages displaying company, product, or other information the advertiser wishes to provide. Project templates may define a rigid set of possible pages that cannot be edited, or may define a starting set of pages that the user can modify by adding, removing, reordering, or restructuring the flow of pages, or may be based on various factors including lines of business (automotive, publishing, music, film, consumer electronics, fashion/apparel, etc).

The next step is defining the types of pages to be included in the project. The project templates may define the types of pages to be used or they can define the category of each page and allow the user to select from a range of page templates in that category. For example, the project template can define that one of the pages is intended to be a “menu.” The user can select from a range of possible menu “page templates” to apply.

Once a page template has been applied (either as determined by the project template or manually selected by the user), page-specific attributes can be edited, for example: the background color of the page, the size of the page, the orientation of the page, other page template specific properties, number of elements in a gallery, the default location for a map, and so on.

The next step in the process is adding content to the pages in the project. The page templates contain placeholder elements for content to be provided by the advertiser, for example, an image placeholder to be filled in with a company logo or product image. Placeholder elements may have pre-determined styles applied to them, for example, a button with a preset color, border, opacity, etc. In such a case, the user need only provide text for the title of the button. In some aspects, the styles may be rigid and non-modifiable by the user, while in other aspects, the styles may be set initially but editable by the user by editing individual parameters, e.g., background color, border color, etc. In some embodiments, the styles are edited visually using an inspector rather than by specifying the CSS attribute and value, thus eliminating the need for in-depth knowledge of CSS properties. The styles can also be edited by applying a style preset representing a number of style elements and their associated value, e.g., “red flame” style with red gradient background, bright orange border, and yellow glow shadow.

In some instances, placeholder elements can be “pre-rigged” with animations that persist after an element has been customized by the user. For example, an image element set to fade in when it is first displayed. Some elements can represent multiple content items in a list, grid, or other “gallery” or “container” style display, such as e.g., a “carousel” of videos, a sliding gallery of images, a scrolling view of a very large image or set of images, etc. Some elements can represent multiple “cells” in a list, grid, or other “gallery” or “container” style display, with multiple content elements within each “cell”, e.g., a “carousel” containing a video, title, and short description, a sliding gallery of movie character images with audio buttons that plays a voice clip from the character, etc.

Content can be added to a project in a variety of ways. For example, text content can be modified by typing new values into the item, or by typing into a text field in its inspector. Content can be can be dragged and dropped onto a placeholder, even a placeholder containing other content.

The application also supports the creation of content for devices with different hardware characteristics such as display size, resolution and/or device orientation. Page templates and page elements can automatically select the appropriate content for the target environment (device hardware). For example, page templates are provided for specific device resolutions, page templates are provided for specific device orientations (e.g. portrait and landscape), and page templates can handle changes in a device orientation and reconfigure their elements as changes occur. Page templates may be limited to a single display resolution, relying on hardware scaling of the video output by the device or they can handle changes in display resolution and reconfigure their elements as change occur. For example, the templates can animate elements to new sizes/positions as resolution changes, scale bitmap objects to fit the new resolution, substitute bitmap assets with new assets appropriate for the new resolution.

An advertisement can contain multiple “renditions” of content to be automatically selected by at runtime for optimal display, e.g., normal and hi-res versions of bit-map images for display at different scales/display resolutions, multiple bit rate video streams to be selected based on network, device, or other criteria for optimal user experience.

Multiple renditions may be provided to the advertisement manually by the user, or they may be provided automatically by the application by downsampling a “hi-resolution” version to lower resolution versions as needed or by down sampling an ultra-resolution “reference” version to a “hi-resolution” version and all subsequent lower resolution versions as needed. In the case of automatic down sampling, this can be done based on the original asset dimensions assuming it will be displayed at its natural size, e.g., a 100×100 pixel image can be down sampled to a 50×50 image if the hi-resolution and lo-resolution requirements differ by 50% in each dimension.

In addition to dimension-based “renditions”, bandwidth-based “renditions” may also be created, and other advanced optimization techniques can be applied, to ensure optimal download speed over varying network types (EDGE, 3G, WiFi).

To ensure compatibility with the advertisement server, networks and known devices, image assets are analyzed to ensure they meet size requirements such as a maximum total size, and maximum image resolution based on bits-per-pixel (BPP), e.g., EDGE network: <0.75 BPP, 3G network: <1.0 BPP, and WiFi: <2.0 BPP.

Video assets are analyzed to ensure they meet size requirements such as a maximum total size and maximum data rate, e.g., EDGE: 80 kbps, 3G: 300 kbps, and Wi-Fi: 1000 kbps.

System-generated and user-provided text assets are processed. For example, JavaScript is concatenated and minified, CSS is concatenated and minified, HTML, JavaScript and CSS is compressed, etc.

Advanced techniques are applied to image assets: multiple images are combined into a single “sprite” image to speed up downloading (one HTTP request versus multiple); HTML, CSS and JavaScript reedited to refer to the new sprite; individual images are inlined as base 64 data into HTML files to minimize HTTP requests; and a web archive is created as a single initial download (tar/zip) with essential advertisement elements.

The system includes the ability for users to add custom JavaScript code in a variety of ways. Write handlers that implement responses to events generated by the system. Such events can include: 1) a button was pressed; 2) the user touched the screen; 3) a new page was navigated to; and 4) the advertisement application was paused, or resumed. Custom JavaScript code can also be used for implementing custom on-screen controls (buttons, sliders, etc.); implementing custom on-screen display elements (views, graphs, charts); implementing custom logic (calculators, games, etc.); and integrating with WebServices functionality, etc. Any custom elements can also be saved for reuse in other projects.

During development of the HTML 5 application, content and functionality can be verified in an interactive environment by on-screen preview within the authoring environment and by toggling the editing “canvas” from authoring mode to interactive mode causing the on-screen elements to become “live” and respond to user input. The project can also be exported to disk such that it can be opened and viewed by the appropriate client application on the users local machine such as a web browser, other desktop reader application, mobile web browser, or other mobile reader application. Additionally, the project can be exported to a shared network location so it can be opened and viewed by the appropriate client application on a remote, network connected machine. Exporting to a shared network location also allows the project to be opened and viewed by the appropriate client application running in a local simulated environment. Another mechanism of exporting is to publish the content from within the authoring tool that allows access to the content via an appropriate client application running on a mobile device. In some embodiments, live changes can be made in the authoring environment and are published to the viewing application.

In some testing embodiments, the application can be modified in the editing tool, and the changes automatically appear in the testing application. Before each simulation, each testing tool can contact the editing/authoring tool to retrieve the most recent version.

As addressed above, testing and previewing the authored application can be an extremely important step, especially for those that are using the authoring tool professionally. Accordingly the authoring tools testing simulations include the ability to test in many different network states as well so as to simulate the real world operation of the application. In some embodiments, the authoring tool can simulate a fast connection becoming slow so that the content creator can view how the advertisement might look if the server decided to send a lower resolution asset based on its real time analysis of network condition.

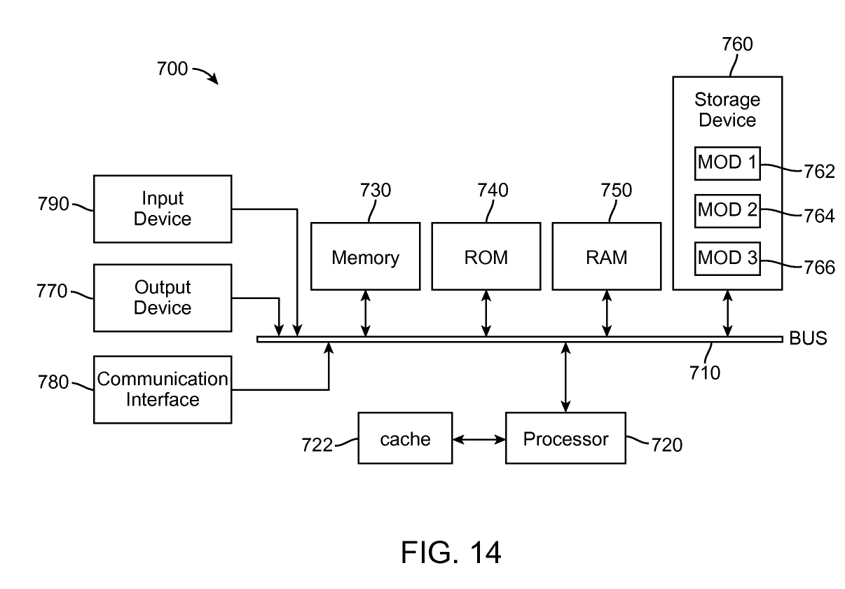

As shown in FIG. 14, an exemplary system 700 for implementation of the present technology includes a general-purpose computing device 700, including a processing unit (CPU or processor) 720 and a system bus 710 that couples various system components including the system memory 730 such as read only memory (ROM) 740 and random access memory (RAM) 750 to the processor 720. The system 700 can include a cache 722 of high speed memory connected directly with, in close proximity to, or integrated as part of the processor 720. The system 700 copies data from the memory 730 and/or the storage device 760 to the cache 722 for quick access by the processor 720. In this way, the cache 722 provides a performance boost that avoids processor 720 delays while waiting for data. These and other modules can be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a non-transitory computer-readable medium in connection with the necessary hardware components, such as the processor 720, bus 710, display 770, and so forth, to carry out the function. The basic components are known to those of skill in the art and appropriate variations are contemplated depending on the type of device, such as whether the device 700 is a small, handheld computing device, a desktop computer, or a computer server.

Although the exemplary embodiment described herein employs the hard disk 760, it should be appreciated by those skilled in the art that other types of computer-readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example, the functions of one or more processors presented in FIG. 14 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations discussed below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 14 can practice all or part of the recited methods, can be a part of the recited systems, and/or can operate according to instructions in the recited non-transitory computer-readable storage media. Such logical operations can be implemented as modules configured to control the processor 720 to perform particular functions according to the programming of the module. For example, FIG. 14 illustrates three modules Mod1 762, Mod2 764 and Mod3 766 which are modules controlling the processor 720 to perform particular steps or a series of steps. These modules may be stored on the storage device 760 and loaded into RAM 750 or memory 730 at runtime or may be stored as would be known in the art in other computer-readable memory locations.

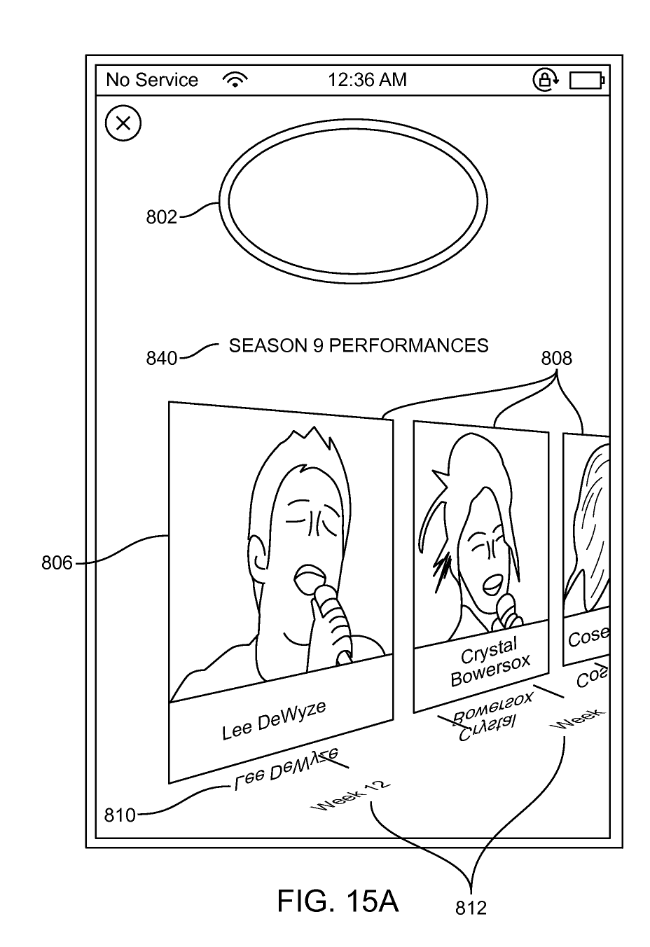

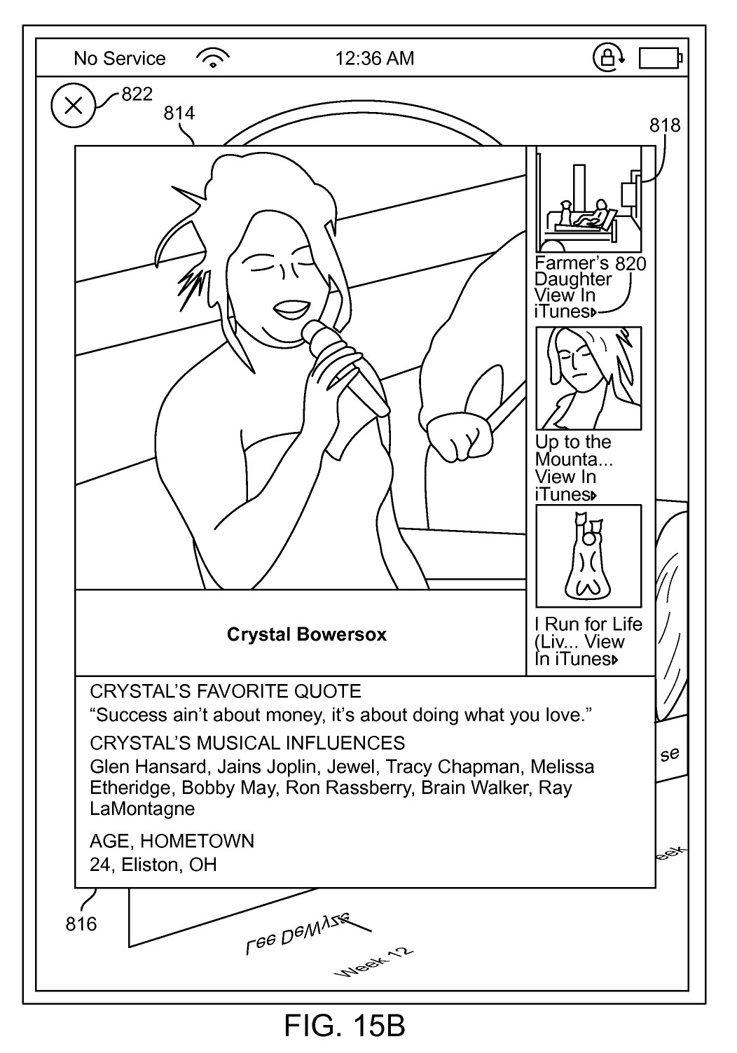

As mentioned above, a JavaScript library can include complex “composite” elements. FIG. 15A illustrates a perspective wall JavaScript element. The perspective wall JavaScript element is a virtual wall with one or more rows 806 of files or items 808, where the wall is set at an angle from a user such that the row or rows 806 stretch into the distance. The items 808 can be pictures, logos, text, etc. Above the wall, there can be pictures or logos 802 and text 840 for informational, descriptive, branding, etc. purposes. Below the wall, there can be intriguing visual effects, such as virtual mirror reflections 810 of the row or rows 806, or descriptive text 812 on wall “floor” (i.e. the plane perpendicular to the wall but intersecting with the bottom of the wall). A user can use a swiping gesture to “scroll” (i.e. move the row or rows 806) and navigate along the wall to different files or items 802. Furthermore, the row or rows 806 can optionally wrap around to form a virtual infinite loop of items 808 (i.e. by connecting the first item to the last item) for the user to scroll through.

FIG. 15B illustrates how a user can tap or select an item 808 to cause it to “pop out” or “fly out” and enlarge 814 to show more details 816 about it. Moreover, additional pictures (i.e. album cover art) 818, data (i.e. song titles), or links (i.e. to an online digital content store such as ITUNES) 820 can be provided to give information to the user or to enable the user to directly purchase the file or item 808 without having to go to an online store to search for it. At any time, the user may close the content (and return to the state before the content) by selecting the close button 822.

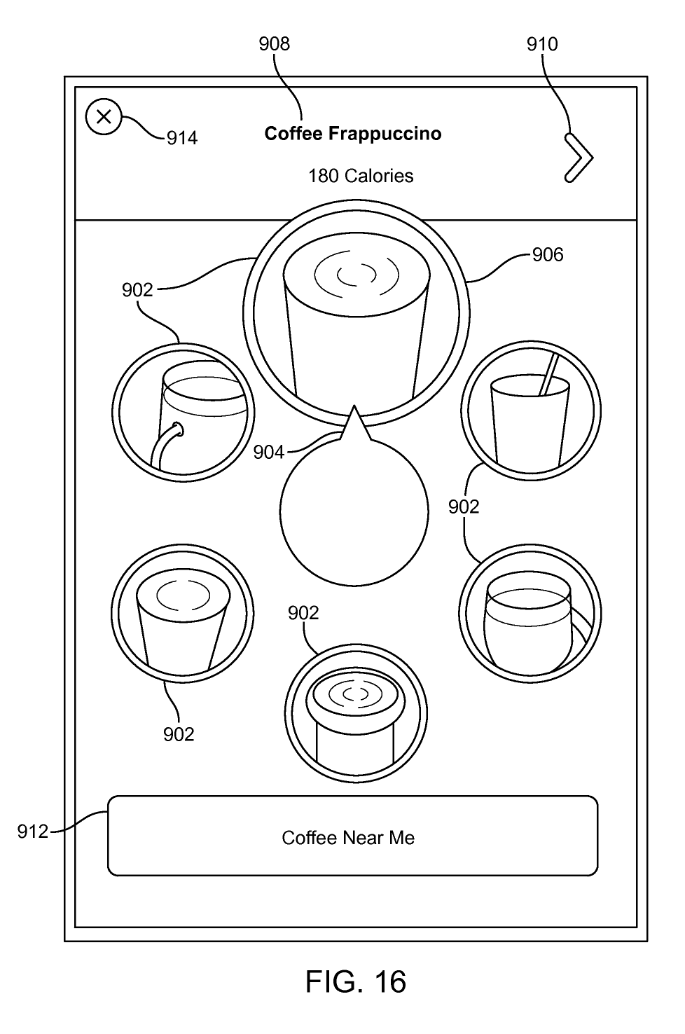

FIG. 16 illustrates a pinwheel menu JavaScript element. The pinwheel menu JavaScript element is a virtual wheel functioning as a circular menu allowing a user to select from a multitude of items or files 902. The user can use his/her thumb or finger to rotate the pinwheel until the item he/she wishes to select is at the “selected” position. The “selected” position can be defined by an arrow 904 and can be any position in the pinwheel. In this example, the “selected” position is in the top position. Thus when an item is in the top position 906, the item becomes “selected.” When a particular item is selected 906, it becomes larger in size than the rest of the unselected items. As such, when items are rotated around the wheel, they grow in size as they pass through the “selected” (i.e. top) position and shrink after coming out of the “selected” position.

The pinwheel can also be spun, so that a random item is chosen. This allows for an interactive and engaging way for the user to choose a random item. There can also be a detail portion 908 on the screen that displays more information about the selected item. Tapping the selected item again 906 or pressing a button on the screen 910 can bring the user to a new page with even more detailed information. Additionally, a special button 912 can be provided for the user to find nearby locations where the item is offered. The pinwheel menu and content can be closed by the user at any time by pressing the close button 914.

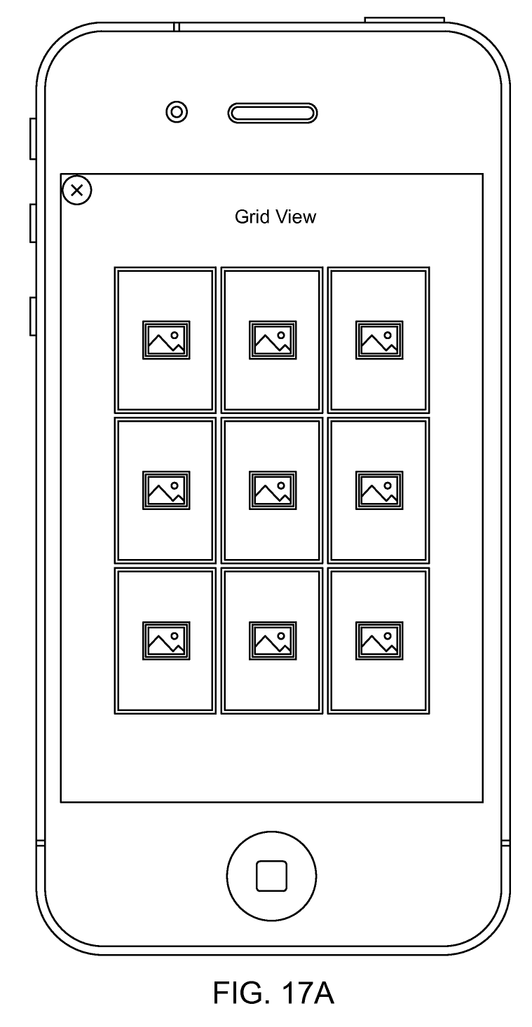

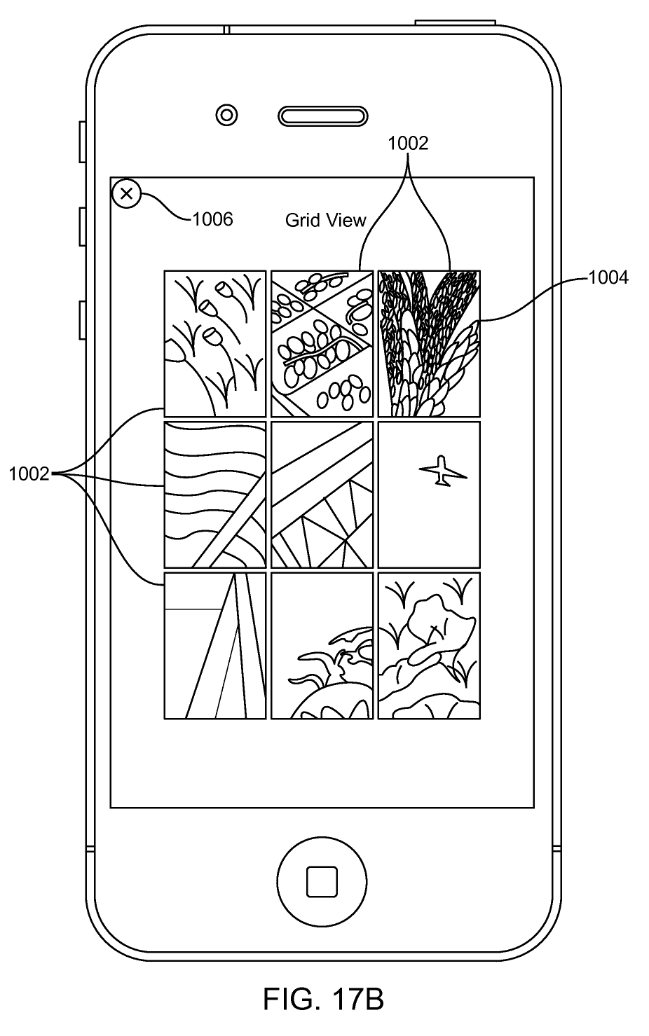

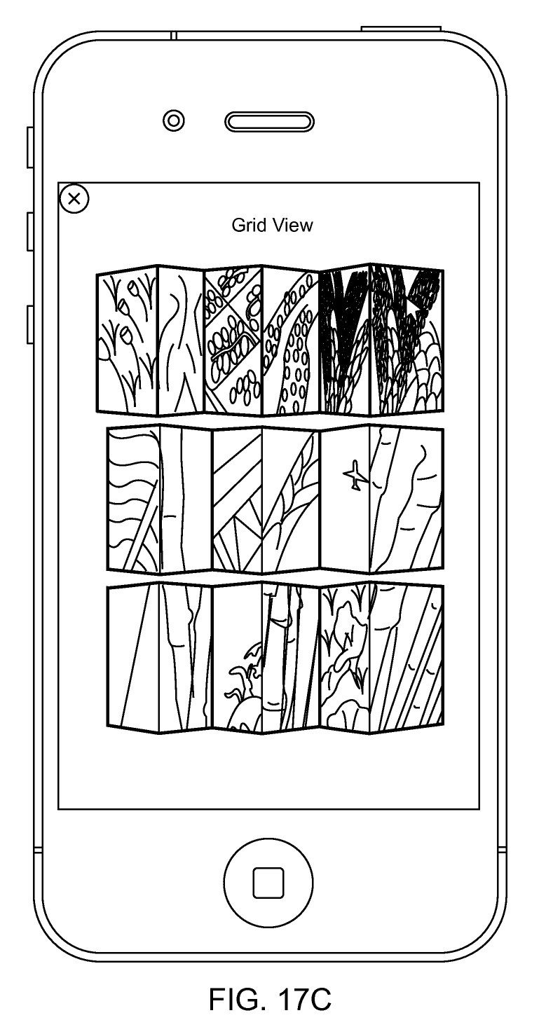

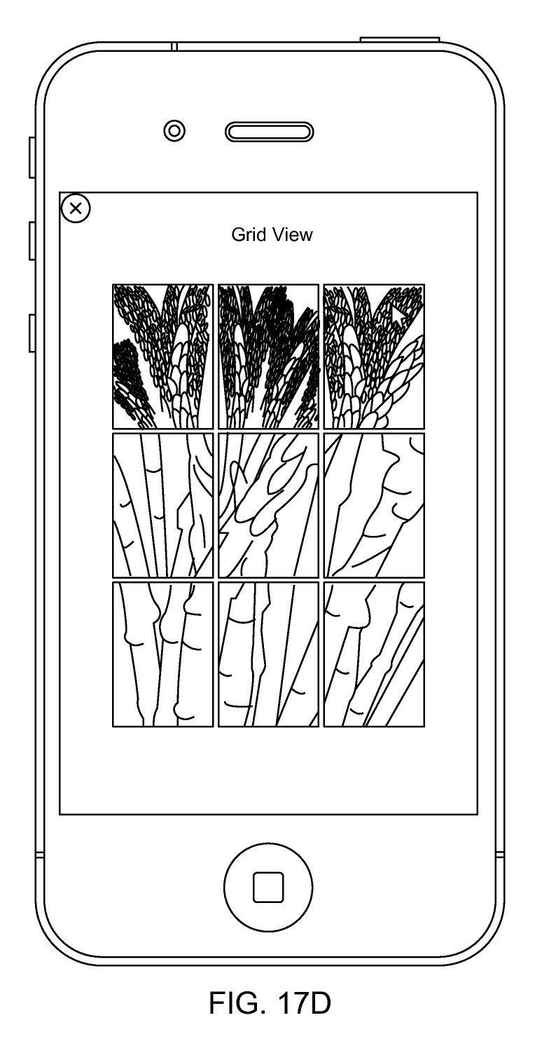

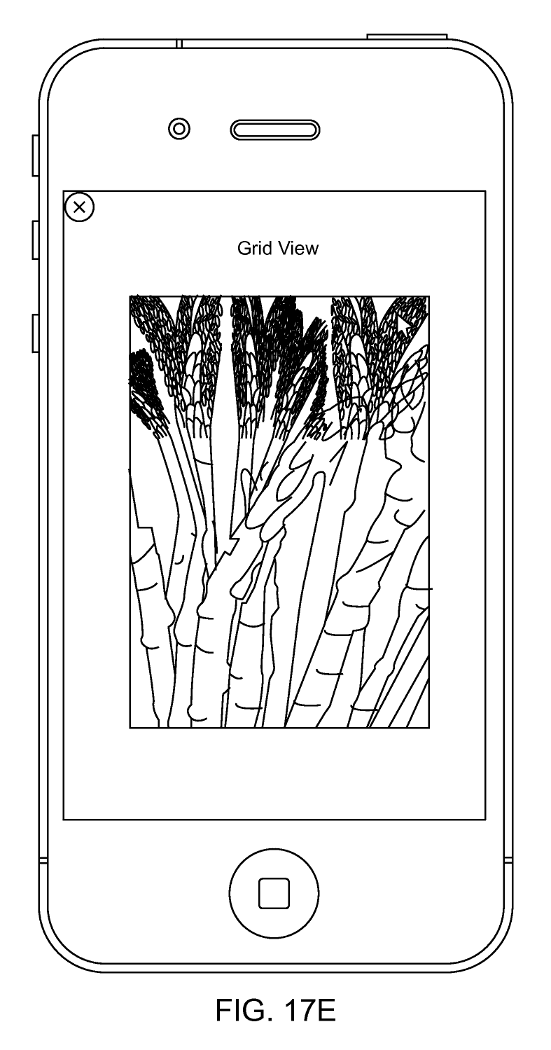

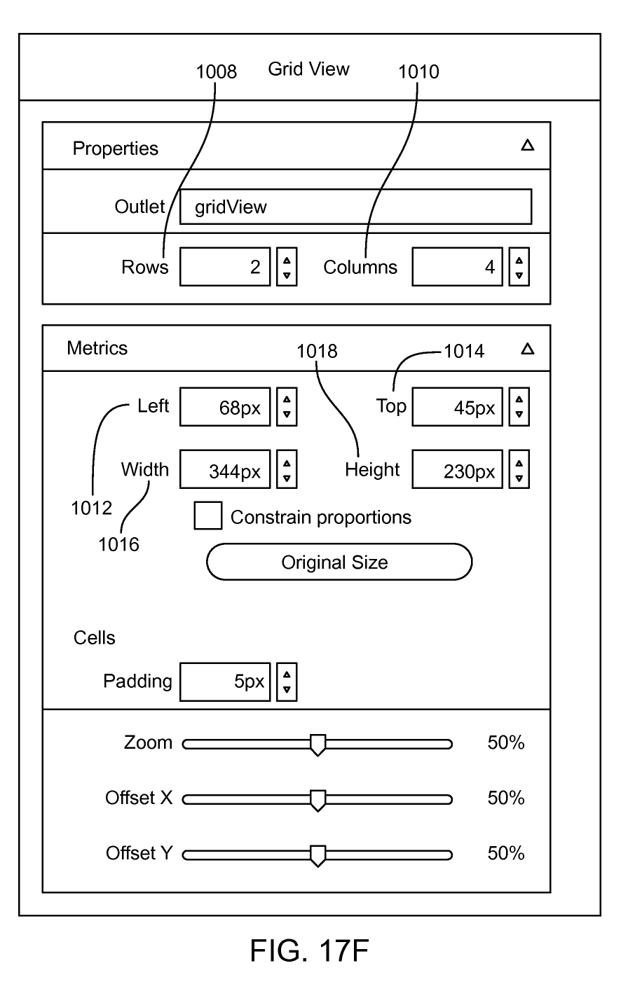

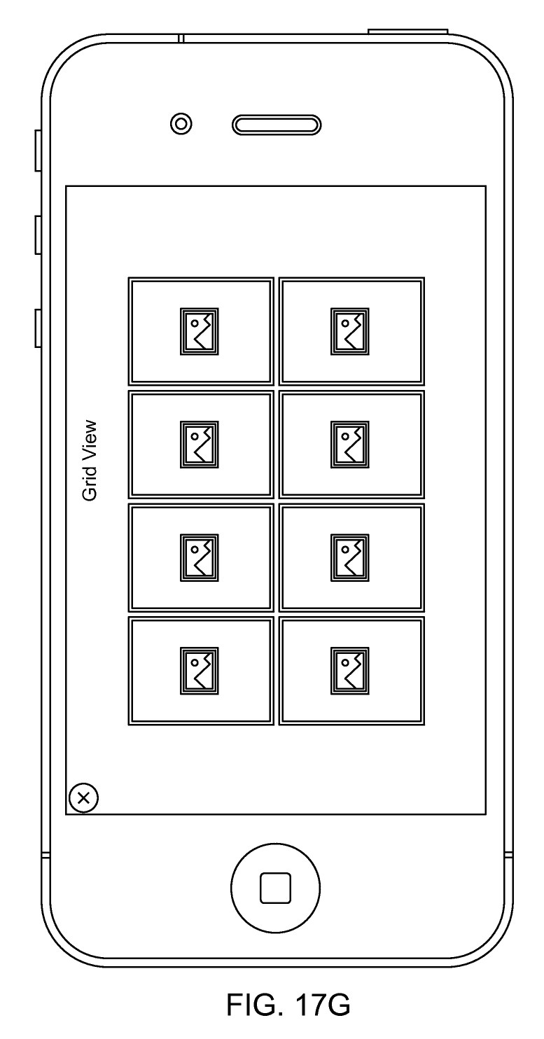

FIG. 17A illustrates a bare N×M gallery JavaScript element with 3×3 sections (i.e. N=M=3), but not yet supplemented with content. N and M are positive integers greater than 0. FIG. 17B displays an example 3×3 gallery JavaScript element containing content. The 3×3 gallery is a collection of nine (i.e. 3×3) items 1002 (which can be depicted by images), each of which can be selected by a user. Initially the collection displays a smaller and/or sectional image for each of the nine items. When the user selects or taps on a particular item 1004, all of the images begin to rotate on vertical axes. During the rotation, it is revealed that each image is actually on the front of a 3-Dimensional rectangular box and the side of each box has a part of a larger full image of the selected item 1004. Each side of the box is of the same size and orientation as compared to each other and as compared to the fronts of the boxes. FIG. 17C illustrates this 3×3 gallery example rotating midway after the user has selected an item 1004. When the rotation is complete, nine parts of a larger full image of the selected item 1004 can be seen by the user. There are still gaps between each of the nine parts; these gaps are not necessary but they allow the user to better see the visual effects of the 3-Dimensional rotation. The nine parts (with gaps in between) of the large full image of the selected item 1004 are shown in FIG. 17D. The nine parts can merge to form a complete large image of the selected item 1004 as illustrated in FIG. 17E. There can be another button or link to offer the user additional information. Also, the user can choose to go back (i.e. by tapping on the large full image, by tapping somewhere not on the image, by tapping on a “return” button) and the blocks will separate and rotate back to the initial appearance displaying all of the images, as shown in FIG. 17B. Again, the user may close the content at any time by selecting the close button 1006.

In some embodiments, widgets or inspectors can also be provided for adjusting known variables within the JavaScript code. For example, in the case of the N×M gallery, an inspector (FIG. 17F) can adjust the N and M parameters (rows 1008 and columns 1010 of the gallery), the effective boundaries (i.e. by adjusting the left 1012 and top 1014 positions) where the content will appear, the width 1016 and height 1018 of the content, and many other details. FIG. 17G shows an exemplary gallery having various variables adjusted with an inspector.

For the perspective wall example, the adjustments an inspector can make include (but is not limited to) altering the shape and size of the files or items, the speed of scrolling, the angle of the wall, spacing between the files or items, the number of files or items visible at once to the user, the degree of transparency of the virtual minor reflection, whether there is information on the wall “floor,” whether the row or rows wrap around, and how text appears.

In the example of the pinwheel menu, an inspector can adjust the number of items, the speed of scrolling, the size and shape of the items, and other details.

While many adjustments can be made to the form or function of user-interface elements to allow users with little or no experience working with code to create high quality content, the present technology also facilitates and allows an advanced user to add new elements or customize new elements.

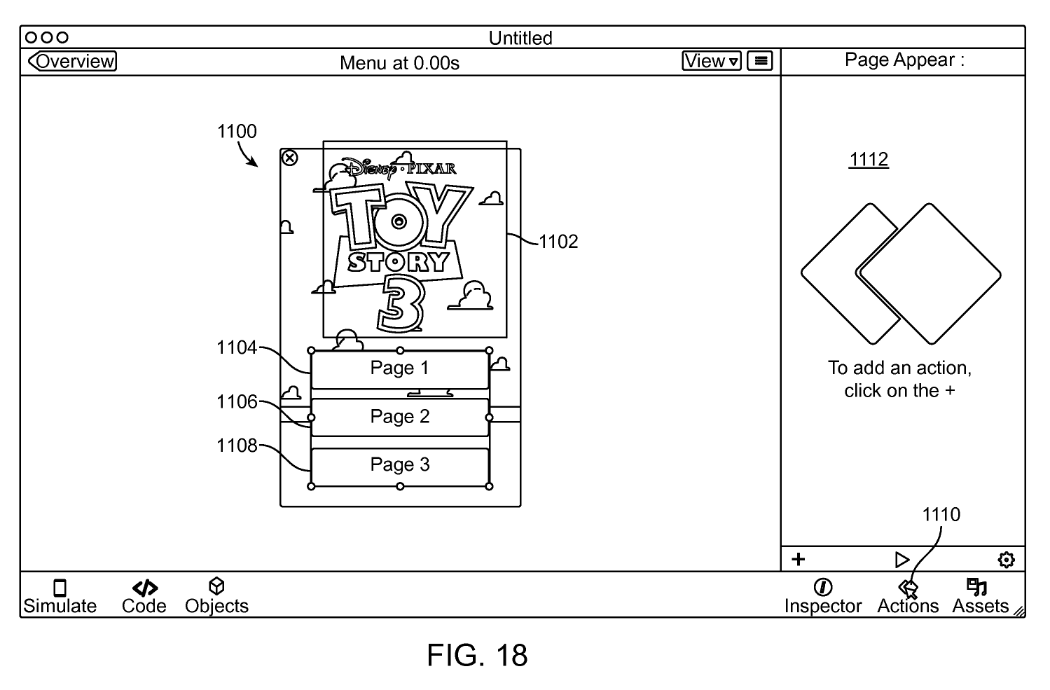

The presently disclosed technology can also facilitate the creation of complex animations through the definition and use of actions. FIG. 18 illustrates an exemplary page of content 1100 authored by the electronic content authoring tool, and an action sidebar 1112. The page 1100 includes a graphic 1102, and buttons 1104, 1106, and 1108, each of which can be associated with actions.

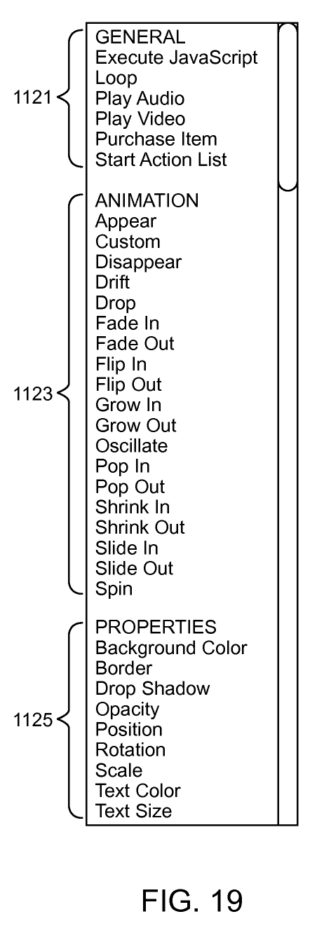

Actions can be used to modify content, introduce content, remove content, move content or otherwise create various effects, modify properties, create animations, and provide transitions, etc. FIG. 19 illustrates an exemplary menu of potential actions. For example, FIG. 19 illustrates a menu listing general actions 1121, actions used in animations 1123, and actions used for adjusting properties 1125 of various assets. It should be appreciated that FIG. 19 does not provide a complete list of possible actions, and further that various actions can be used in combinations with one or more other actions to create complex effects.

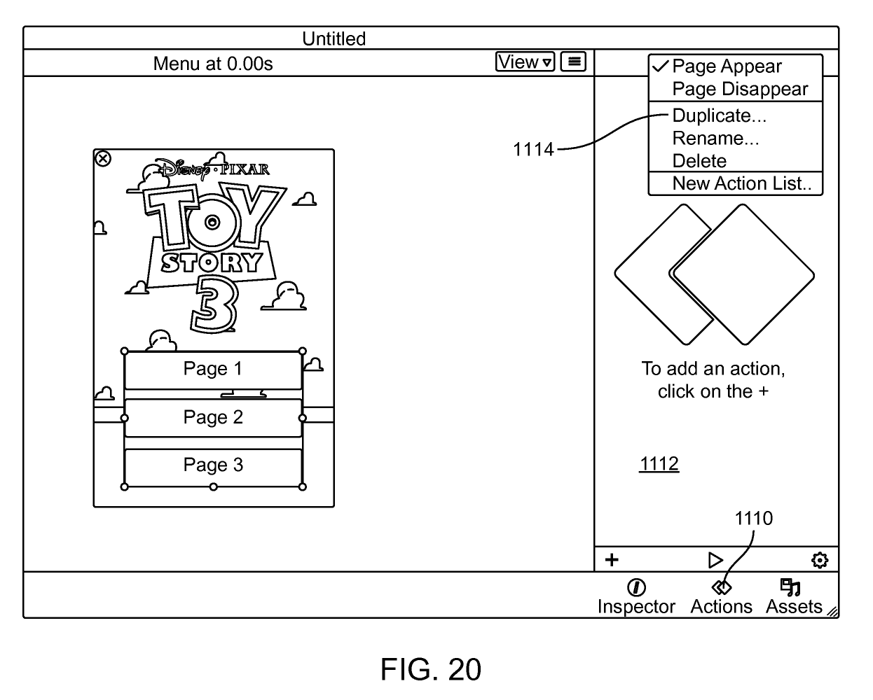

FIG. 20 illustrates an exemplary interface for introducing actions. Actions can be introduced by navigating to the actions sidebar 1112 by clicking on actions icon 1110. Actions are grouped into action lists that can be defined using the graphical user interface menu element 1114 to select a common or previous action list or to create a new action list. As illustrated the page appear action list has been selected as indicated by the check box.

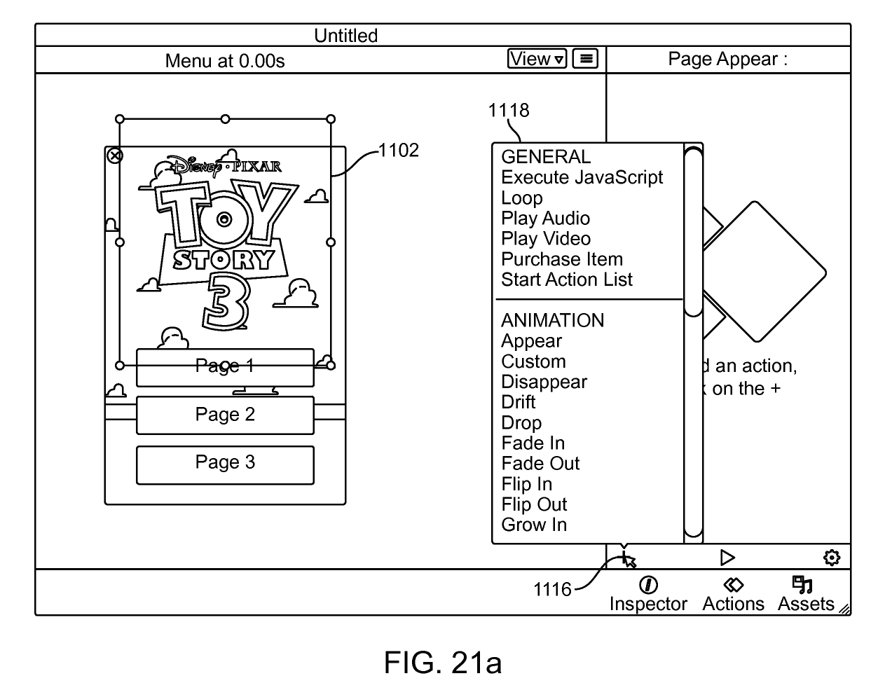

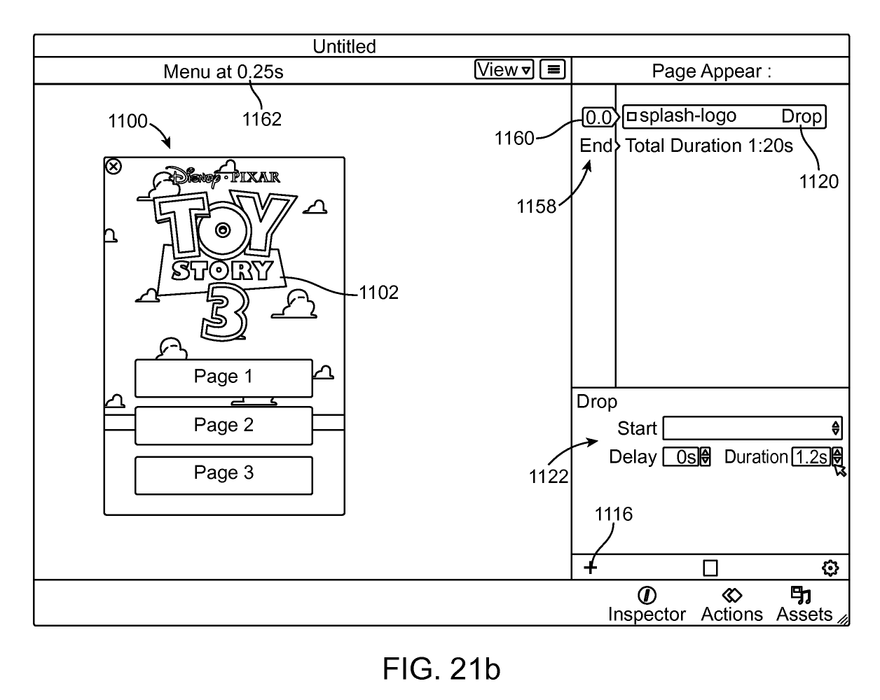

FIG. 21a and FIG. 21b collectively illustrate a drop-in action being associated with graphic 1102. As illustrated in FIG. 21a, graphic 1102 has been selected and a menu of potential actions 1118 to be associated with graphic 1102 is displayed responsive to user selection of “+” (plus sign) 1116. In FIG. 21b, the drop action 1120 has been selected from menu 1118 and is associated with graphic 1102 such that graphic 1102 will now appear on the page by dropping into the page. The drop animation can be previewed right in the content authoring tool, by selecting the drop action 1120. Such a preview is illustrated in FIG. 21b wherein graphic 1102 is illustrated in the process of dropping into page 1100. Although the graphic 1102 is illustrated as being selected, the object, not just the asset can be selected and animated. For example, a text label or empty view can be animated so that the animation occurs regardless of the asset entered into the object.

When the drop action 1120 is highlighted (through user selection) properties 1122 for that action are presented. As illustrated a user can modify the time in which the drop action initiates, whether there is any delay before the drop, and the duration for completing the drop action.

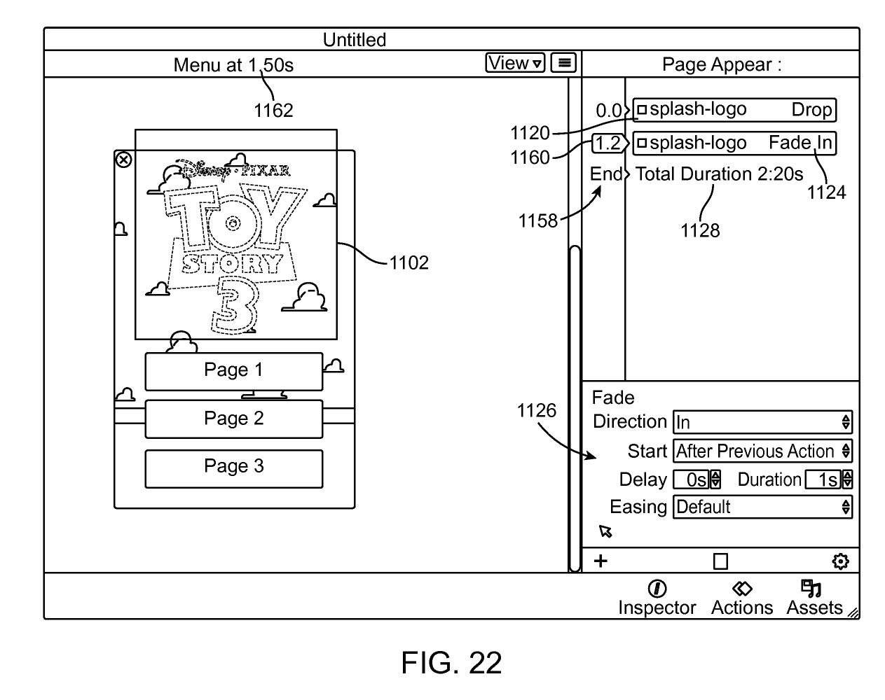

FIG. 22 illustrates a second exemplary action being associated with graphic 1102. A fade-in action 1124 is associated with graphic 1102. As indicated by the properties 1126 associated with the fade in, the action can be configured to start after the previous action (i.e., the drop-in action 1120).

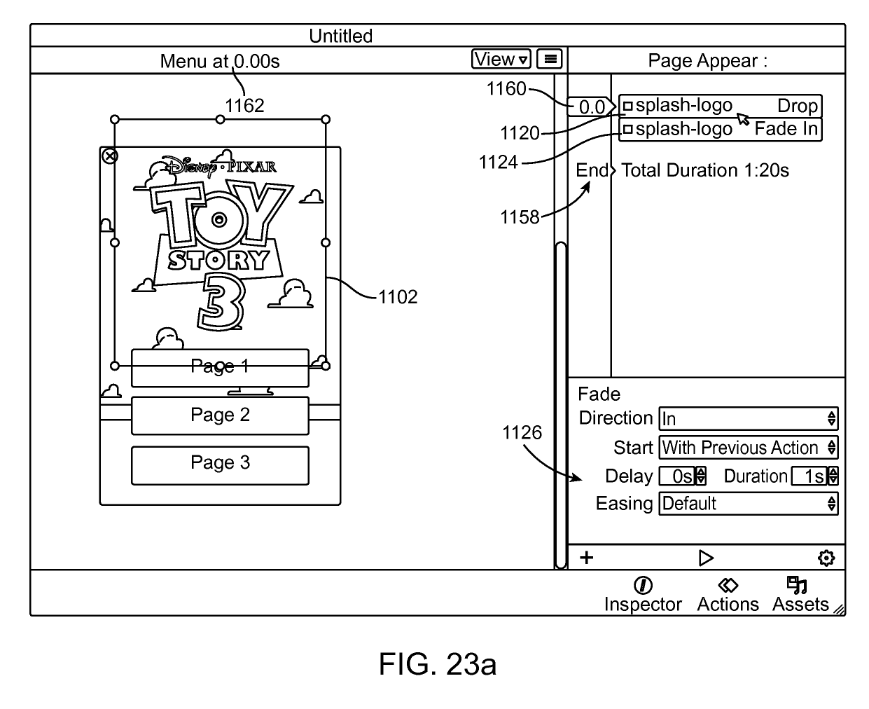

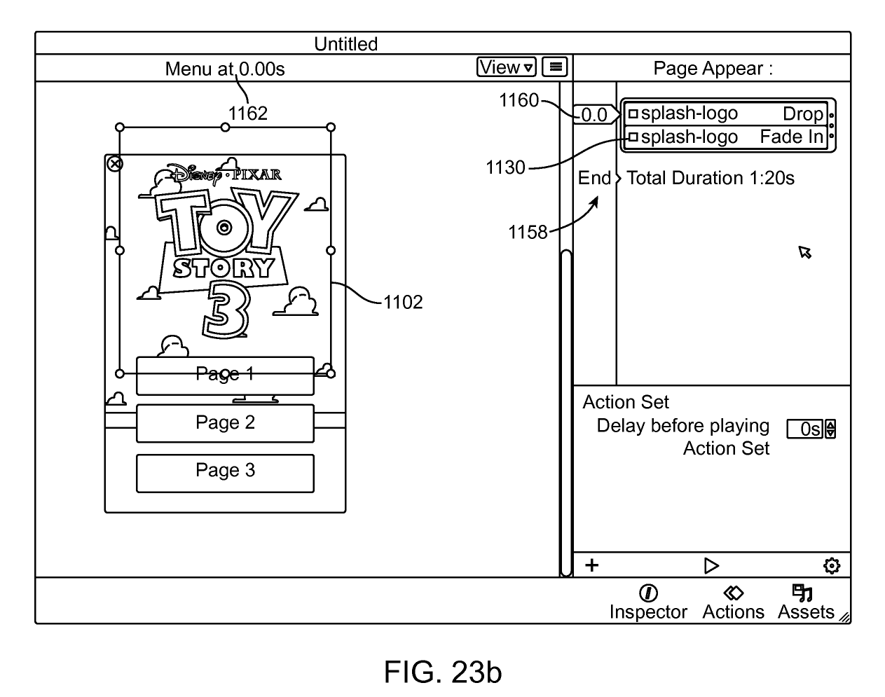

FIG. 23a and FIG. 23b illustrate an exemplary action set. In FIG. 23a, the fade-in action 1124 can be grouped with the drop-in action 1120 to create an action set 1130 illustrated in FIG. 23b. The action set can be created by dragging the fade-in action 1124 on top of the drop-in action 1120 or by adjusting the properties 1126 of the fade-in action so that the fade-in action starts with the previous action (i.e., the drop-in action 1120). Note that the total duration of the drop-in action 1120 and the fade-in action 1124 has decreased from 2.20 seconds 1128 in FIG. 22 (when the drop-in action 1120 and the fade-in action 1124 occur in sequence), to just 1.20 second in FIG. 23a and FIG. 23b (where the drop-in action 1120 and the fade-in action 1124 occur contemporaneously as part of the same action set 1130).

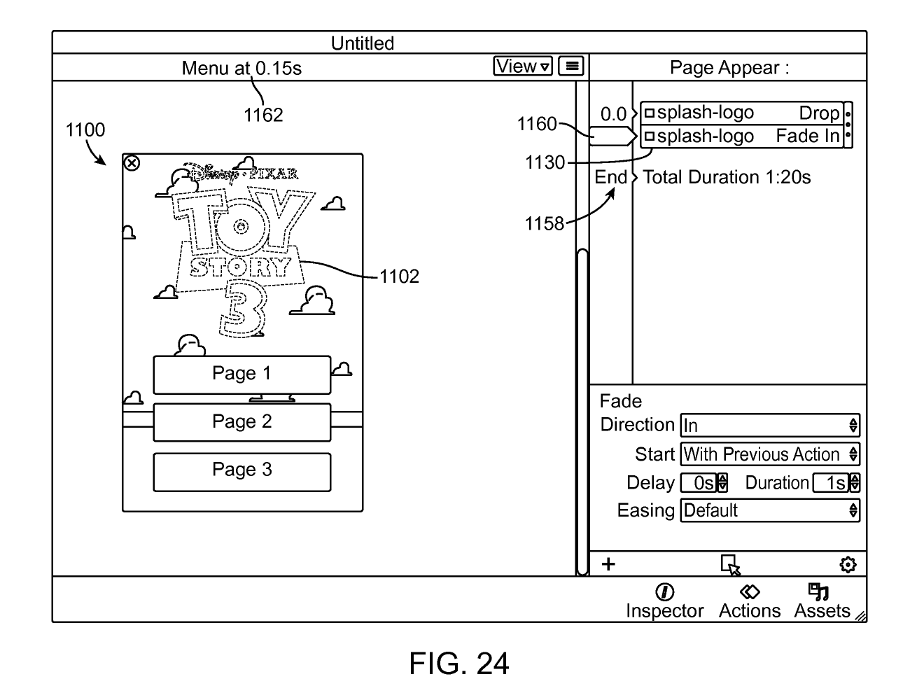

FIG. 24 illustrates a preview of the action set 1130 being used to cause graphic 1102 appearing into page 1100. Note that graphic 1102 is illustrated as dropping into the page and at the same time fading into the page.

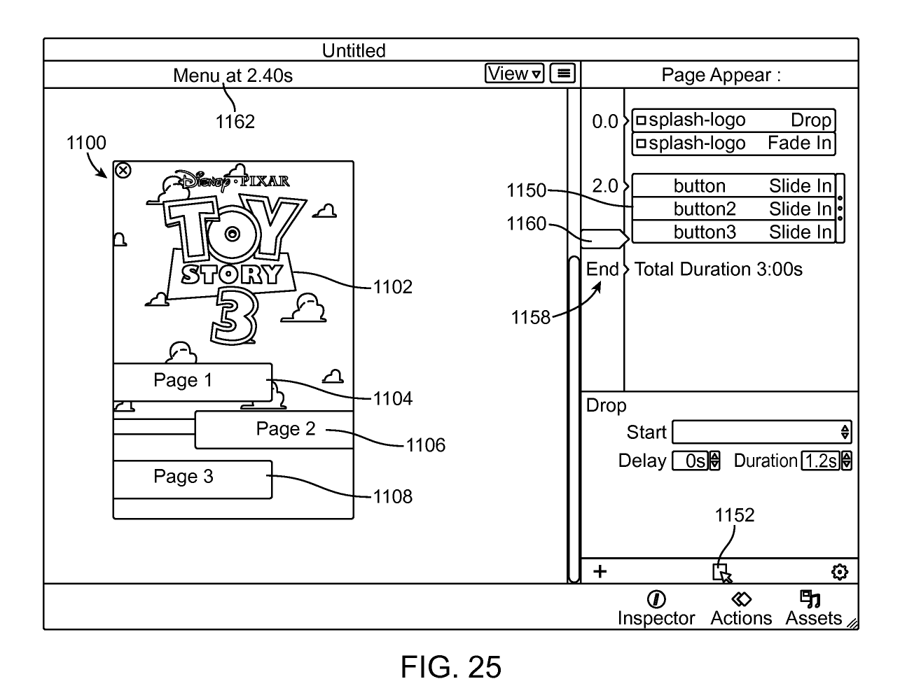

FIG. 25 illustrates an exemplary action set. Action set 1150 is configured to slide buttons 1104, 1106, and 1108 into page 1100 simultaneously as soon as 1102 has finished its transition into page 1100. Action set 1150 can be created in several different ways. In some embodiments action set 1150 can be created by selecting buttons 1104, 1106, and 1108 at the same time, and associating the same action with the buttons. In some embodiments, action set 1150 can be created by associating an action with each button, and using the properties menu to make each action start simultaneously. In some embodiments, action set 1150 can be created by dragging an action on top of another action. Once an action set has been created, each individual action in the group can be modified. Actions can also be removed from action sets by dragging them out of the group, deleting the action, or by adjusting the properties of an action so that the action starts at a different time than the other actions in the action set.

Also illustrated in FIG. 25 is a preview button 1152. At anytime, the full action list can be previewed by selecting the button 1152. Alternatively, a specific action or action set can be previewed by first selecting the action or action set and then selecting the button 1152.

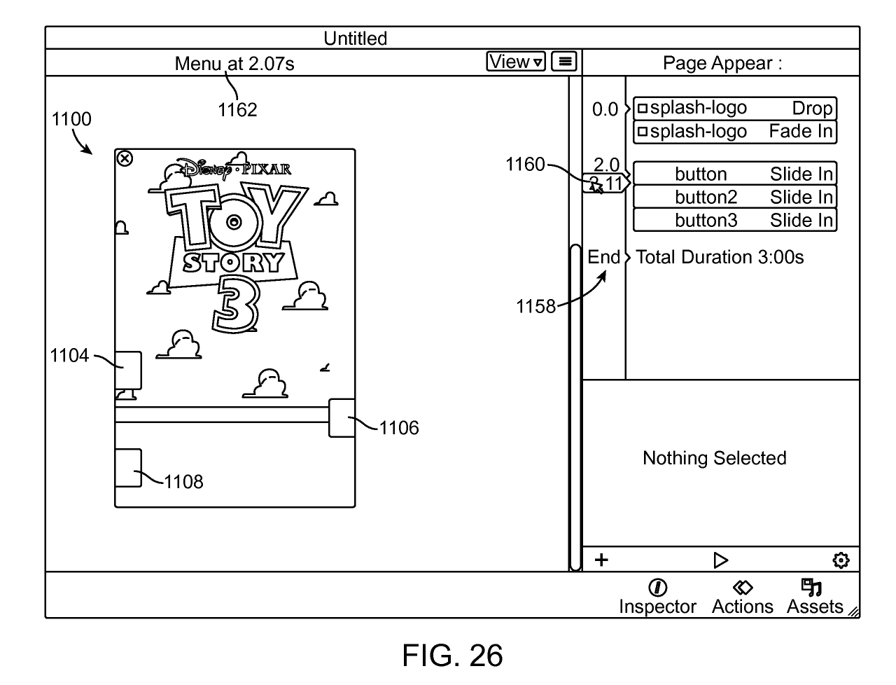

FIG. 26 illustrates an exemplary preview slider embodiment. Each of the actions and action sets are scheduled to start at a given time and have a specified duration in which to complete. In some embodiments a content developer can preview the actions and animations by manipulating a preview slider 1160 along a time axis 1158. As illustrated in FIG. 26 a developer has manipulated the preview slider 1160 along the time axis 1158 to 2.11 seconds and the animation on page 1100 is illustrated at approximately that point in time. As illustrated graphic 1102 has completed its appearance transition (drop and fade in), and buttons 1104, 1106, and 1108 are sliding into the page 1100. Playtime indicator 1162 shows that the animation is shown at 2.07 seconds. By dragging the slider the animation on page 1100 updates to show how the page would look at approximately that time during live playback.

Actions and action sets can be implemented by using the asset for which an action is associated to generate the asset into a combination of CSS keyframe sets and JavaScript code snippets. A CSS keyframe set is a standard, low-level way to provide instructions on how to animate the object (as a series of frames) to WebKit. Non-animation actions like Play Video, Change Cell, or Go to Page can be implemented using JavaScript code.

To implement the animations described above, initial keyframes first must be generated. Each action in the action list can provide its keyframes and generate additional keyframes based on its parameters. For example, a drift action can measure the dimensions of the page, measure the dimensions of the element being animated, and create 3 keyframes at 0% (element is offscreen to the left), 50% (element is in the middle of the screen) and 100% (element is offscreen to the right). Actions which require JavaScript can be ignored at this stage.

The keyframe sets generated by the actions above can have keyframes between 0% and 100%. The keyframe set needs to be scaled in time, so that 0% represents the start of the entire action list, and 100% represents the end of the entire action list. So if a fade-in action takes 1 s, and it's followed by a 1 s spin action, then this step will change the fade-in action's keyframe set from 0%: opacity=0, 100%: opacity=1 to 0% opacity=0, 50%=opacity 1.

Next all of the keyframe sets are examined to see which can be combined. Keyframe sets can be combined if they target the same elements, have the same easing functions, and don't overlap. For example, if a fade-out action follows a fade-in action, their keyframe sets can probably be combined.

Next, missing keyframes are filled. All keyframe sets must include keyframes at 0% and 100%. For example, if a spin action takes place in the middle of an action list, it has keyframes at 33% and 66%. The keyframe at 33% can be copied, and inserted at 0%, and similarly the keyframe at 66% can be inserted at 100%. If there are other actions targeting the same object before or after it, then the filling doesn't need to go all the way to 0% or 100%; it just needs to fill up against the boundaries of the other actions. The rules for filling are different for animation actions than they are for property actions. Animation actions fill up against any other actions, while property actions only fill up against other property actions of the same type.

Next, for keyframe sets that target the same element, but can't be combined, and can't even co-exist (because they both target the same CSS property); actions can be introduced through nesting. Keyframe sets that animate position are placed at the outermost level of nesting, followed by rotation sets, scale sets, and finally all other properties, which are placed at the innermost level. This ordering creates an action list that behaves intuitively. The nesting algorithm is as follows: sort the keyframe sets by property (e.g., so that position sets come after rotation and scale ones, etc), then start with the outermost keyframe set and see if it can share a level of nesting with the next innermost one. If it can, place them in the same level and continue until an incompatible keyframe set is found. Then, move onto the next-outermost keyframe set and do the same. Do this until all keyframe sets have been evaluated.

For actions that require JavaScript, some keyframe sets need to be split. If an Action List has an action which requires JavaScript in the middle of it (Fade In->Change Cell->Fade Out), then the keyframe set can be split in half, so that the final output looks like: CSS keyframe set->JavaScript code->CSS. The method looks for all actions that require JavaScript code, and figure out where they fall in the Action Lists. The final keyframe sets that were created above can be split where JavaScript is required at those points in time. The split keyframe sets can then be rescaled so their keyframes span from 0% to 100%.

The full ad unit is then exported, including the CSS keyframe sets inside a CSS stylesheet, the JavaScript code inside a JavaScript object literal, and metadata that describes which CSS keyframe sets should be followed by which JS code snippets, followed by which CSS keyframe sets, etc.

In some embodiments delay is required in the animation. In such embodiments a delay in the Action List can be built into the keyframe sets to yield keyframes which do not animate anything. This provides good animation performance, because if the keyframe set can be handed off to the animation hardware immediately, even if the animation isn't supposed to start immediately which frees up the CPU to perform other tasks right away.

While the method above is explained with respect to a preferred order, it should be appreciated that the order should not be considered limiting of the present technology.

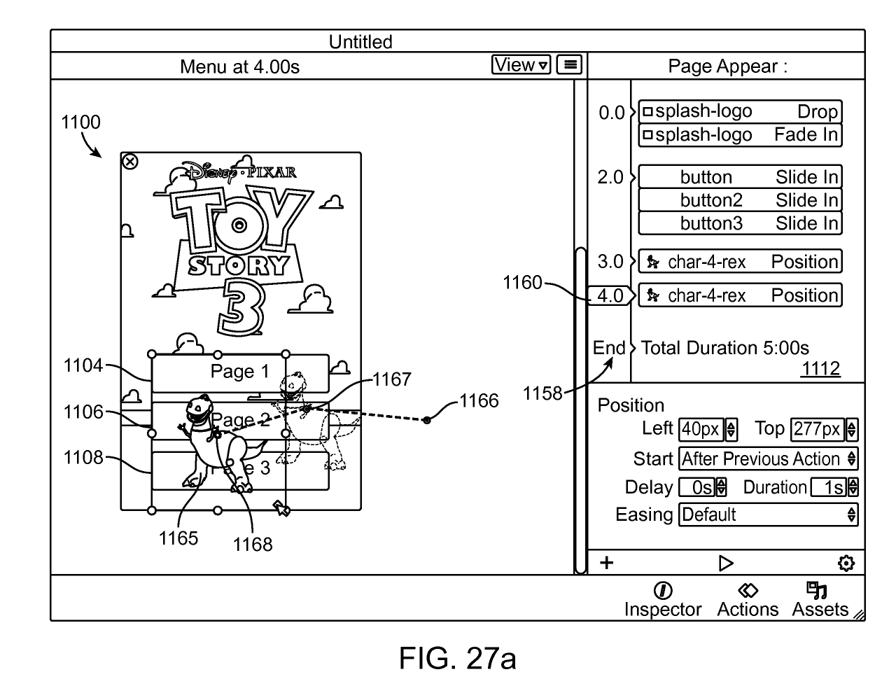

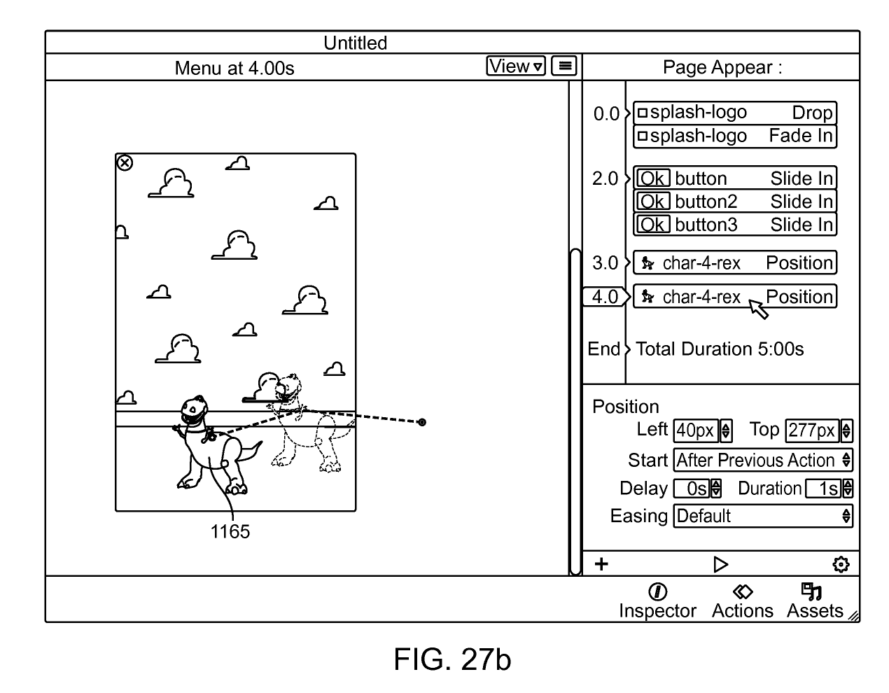

Returning to additional features of the content development tool, FIG. 27a and FIG. 27b illustrate how the present technology can be used to handle overlapping assets. In FIG. 27a, character 1165 has been introduced off the page 1100 at point 1166, its position changed to point 1167, and subsequently changed again to point 1168 to provide an animation of the character 1165 appearing to jump onto and across the screen. This animation overlaps buttons 1104, 1106, and 1108.

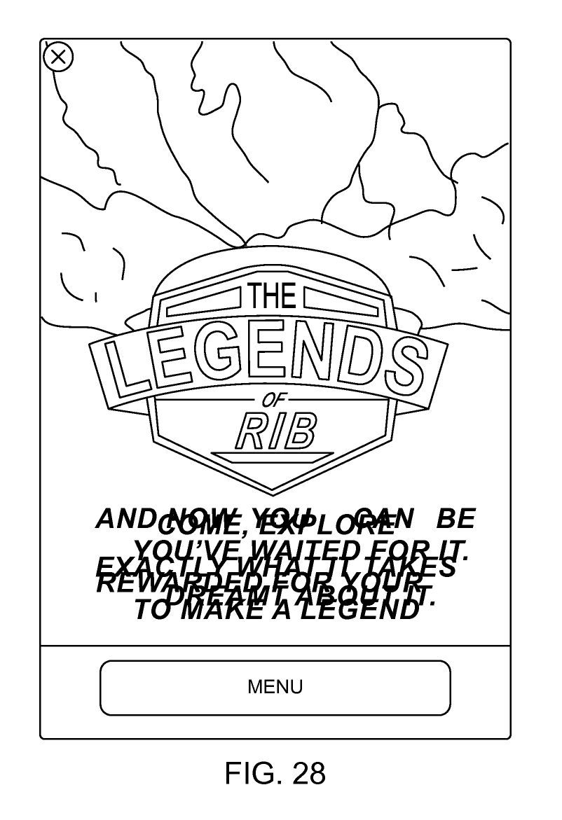

Such scenarios, wherein two or more objects are overlapped on a canvas is a common one not only in application developing, but also in creating presentations. Such scenarios are difficult to work with. Often objects need to be developed on separate canvases or screens and pasted into place because working on the actual page or slide is not practical given the overlapping objects. FIG. 28 illustrates one such example of this where so many words and graphics appear on the page that the text is illegible, and many of the objects cannot be selected because they are under other objects.

FIG. 27b illustrates a solution to this problem wherein by selecting an action from the actions sidebar, only the object that pertains to that action is displayed. In this way, the object can be worked with out interference from the other objects. And as addressed above, actions can be previewed separately or as part of the full-page animation.

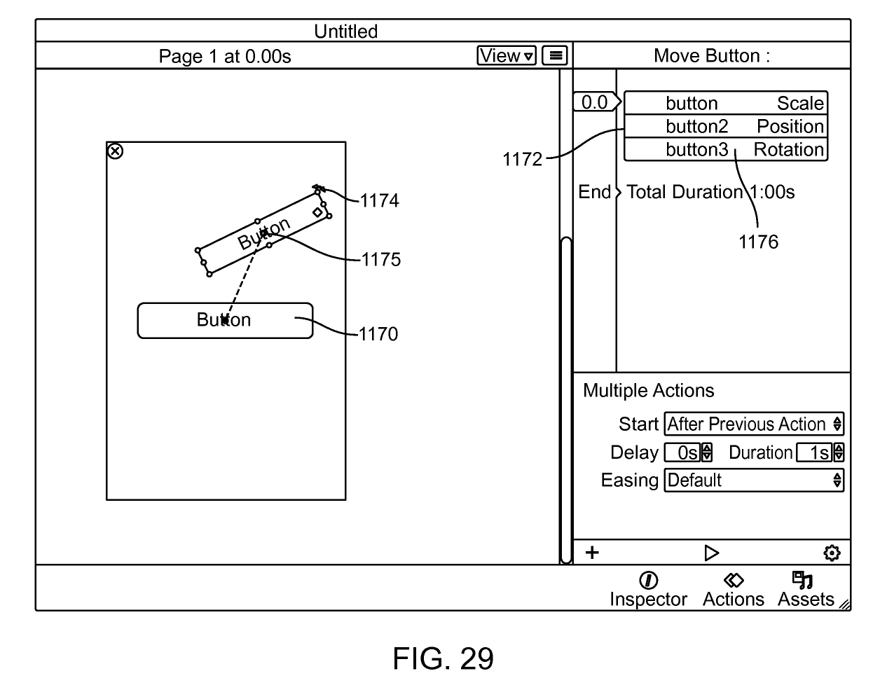

FIG. 29 illustrates an exemplary action that starts on a user action. Button 1170 can be associated with an action set 1172 that scales, repositions the button and rotates the button upon a user click. As illustrated, the content developer has selected an action to reposition the button, which has been completed. The button has been dragged to position 1175. An additional action can also be introduced without selecting the action from the actions menu 1118, by manipulating the button on the page. For example, as illustrated, content developer's cursor 1174 is rotating the button. That act can introduce a new action 1176 as part of the action set 1172.

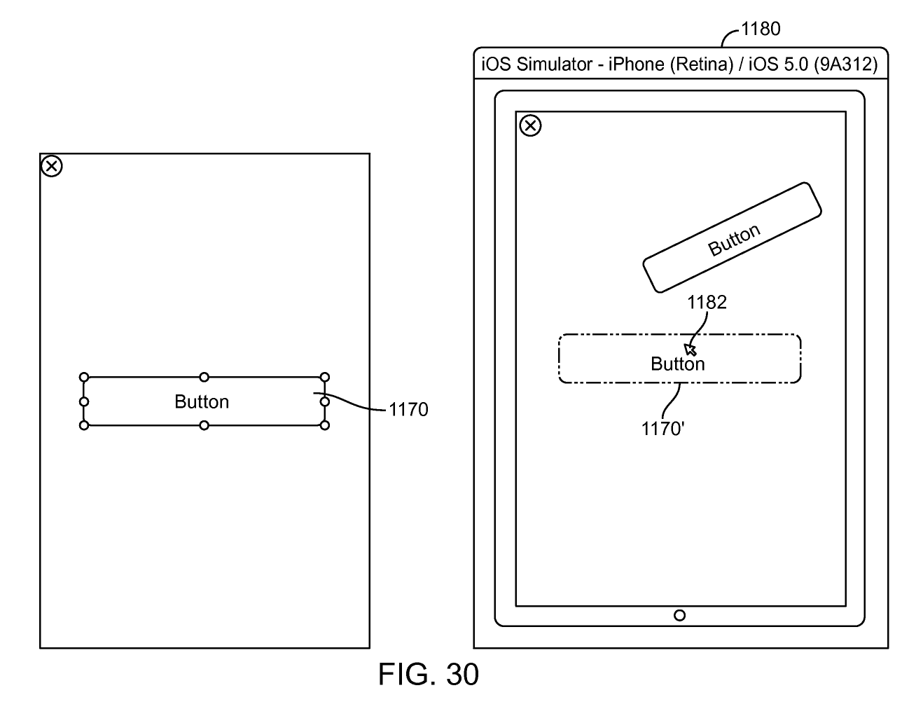

FIG. 30 illustrates an exemplary simulation embodiment. Since the action set 1172 related to button 1170 starts upon a user click, the function and animation of the button can be viewed in a simulator 1180, which is also available from within the development tool. In simulator 1180 the button 1170 can be displayed and upon user input 1182 within button 1170′ (illustrated in broken lines to show where it would have been to start the animation) repositions and scales as directed by the actions in the action set 1172.

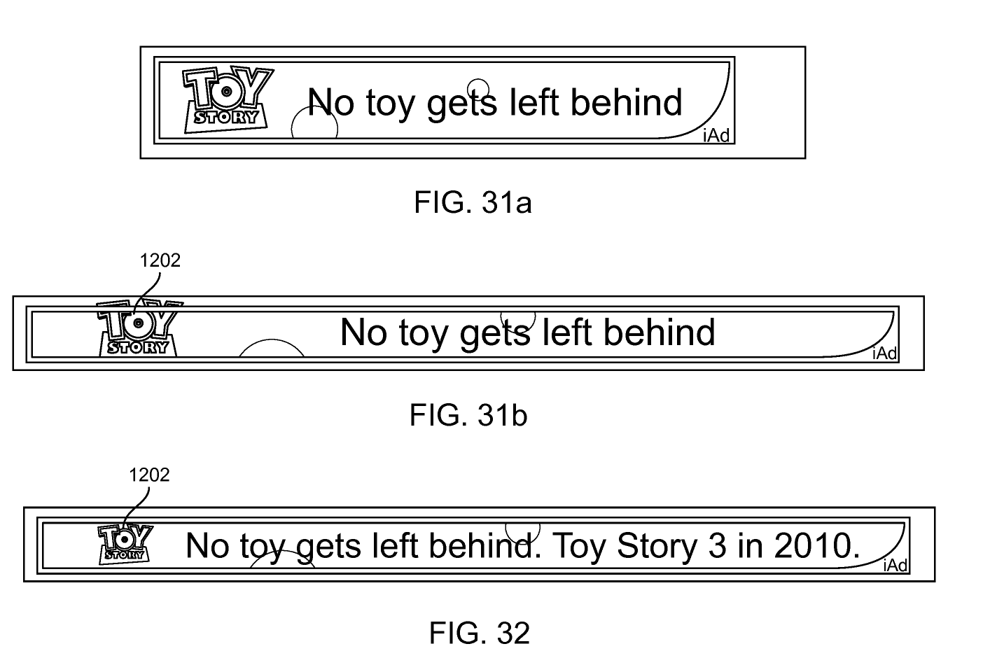

FIG. 31a and FIG. 32b illustrate a banner that can be used to launch an application in portrait and landscape views, respectively. Some devices have multiple possible presentation formats, such as portrait and landscape. In such aspects, it is anticipated that a view in portrait will not be as desirable when viewed in landscape. As illustrated in FIG. 31a, the banner view in the portrait orientation is fatter but shorter than the banner view in the landscape orientation.

When the device is in a first orientation, for example a portrait orientation, and then rotates to a second orientation, for example a landscape orientation, the application banner can resize along with the rest of the content in the device's display.

In order to account for these different views, in one embodiment the development tool can automatically create a landscape view from an existing portrait view. For example, the banner illustrated as FIG. 31b has been automatically generated from the banner illustrated in FIG. 31a. However, the automatic creation of the landscape view might not result in an adequate landscape banner. In this example the graphic 1202 expands outside the border of the banner and therefore will appear cut off. Accordingly the development tool further allows the developer to adjust or modify the automatically created landscape banner. As illustrated in FIG. 32, the developer has shrunk the graphic 1202 and expanded the text to fill out the banner.

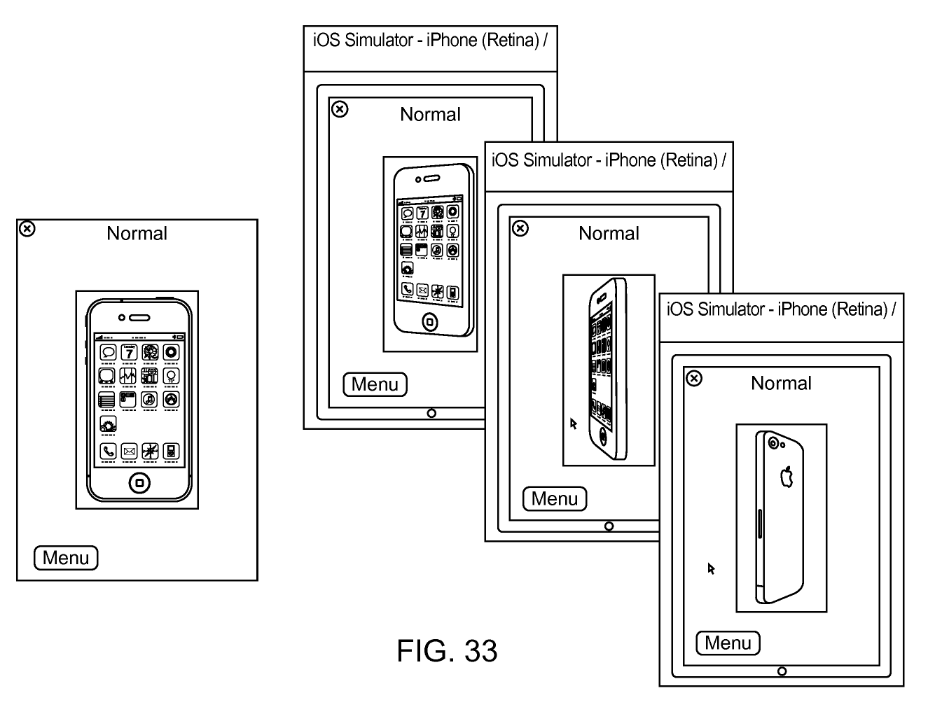

The development tool can also include an editing function for multi-image displays such as a zoetrope. FIG. 33 illustrates an exemplary multi-image display wherein an image of a smart phone is shown being rotated to in a simulator. The 3-D view can be created by displaying multiple views in sequence, just as frames in a movie or a zoetrope.

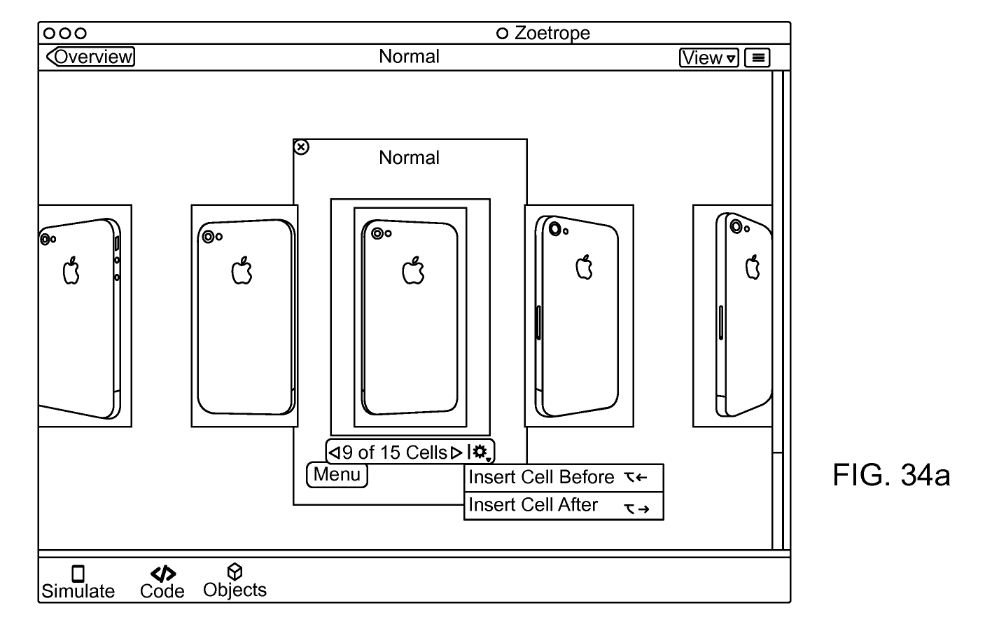

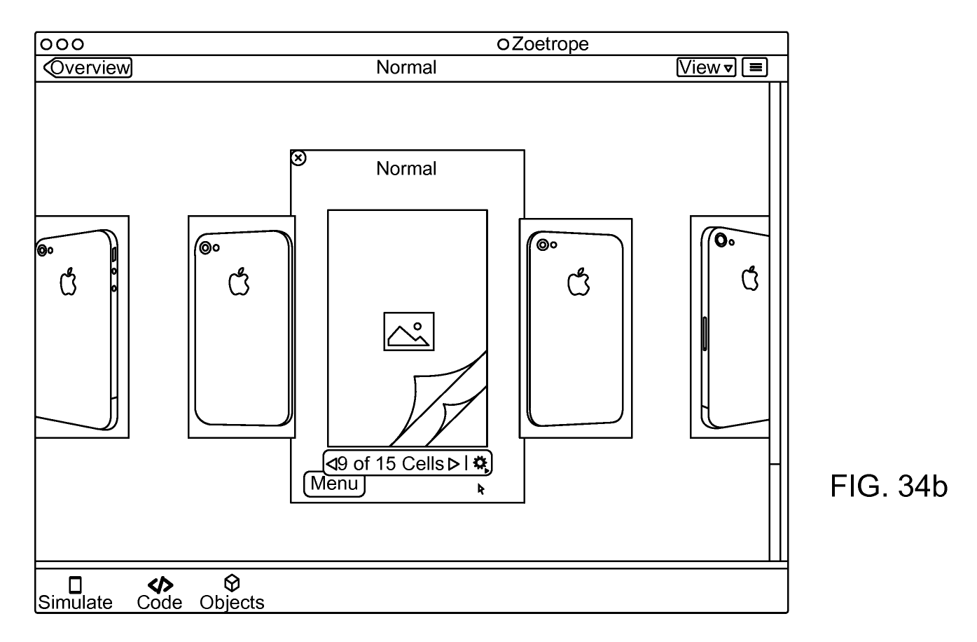

FIG. 34a and FIG. 34b illustrates an exemplary editing embodiment. FIG. 34a illustrates several of the images used by the zoetrope, with the highlighted image being available for editing. Each of the images used in the zoetrope can be selected and edited. FIG. 34a illustrates an embodiment wherein an image can be added or removed from the collection of images used by the zoetrope. FIG. 34b illustrates an additional cell added to the zoetrope wherein an additional image can be added.

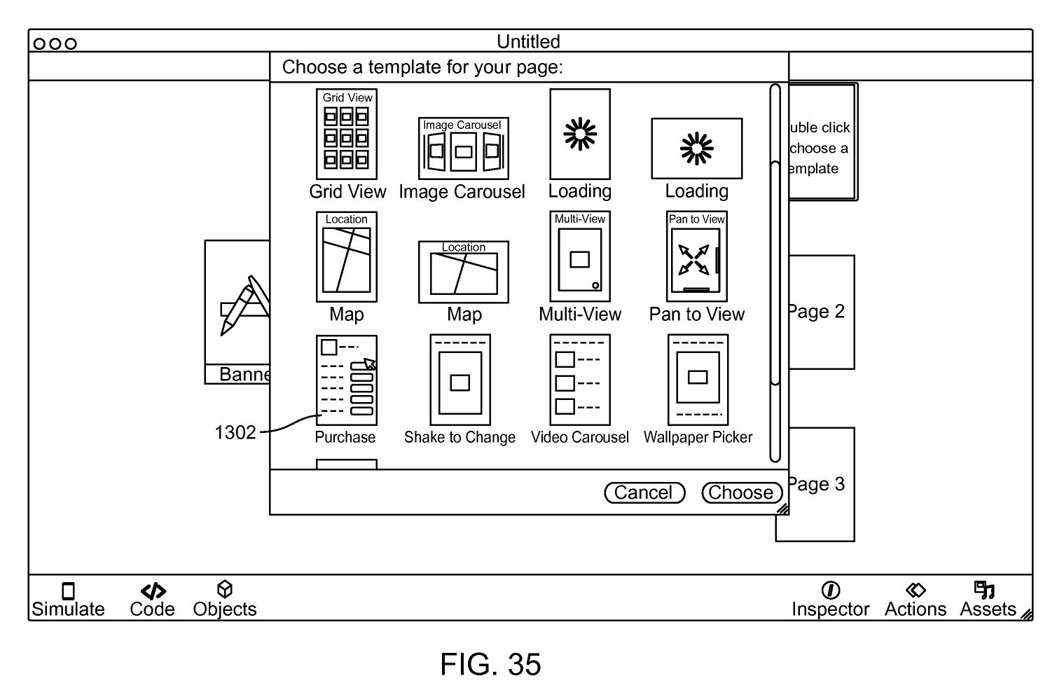

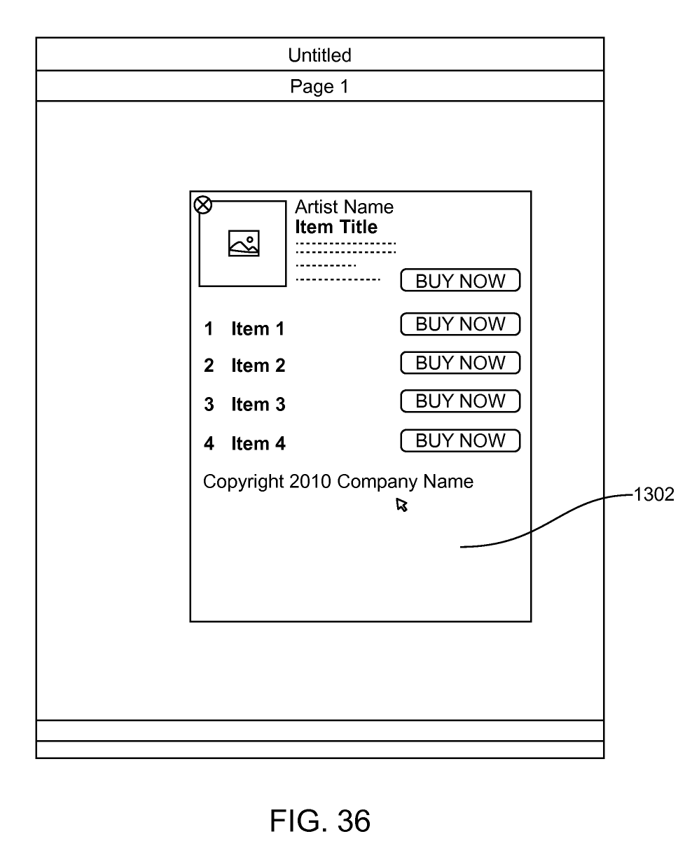

The development tool can also include templates as illustrated in FIG. 35. A series of templates for menu items, galleries, and interfaces is displayed within the development tool. One such template is a purchase template 1302. Templates not only make development of applications easier, but in some embodiments also allow access to interfaces that are already familiar to a target user. Purchase template 1302 can be one example of a familiar interface; it can be a template for a purchase interface to a popular online store. FIG. 36 illustrates the purchase interface template 1302.

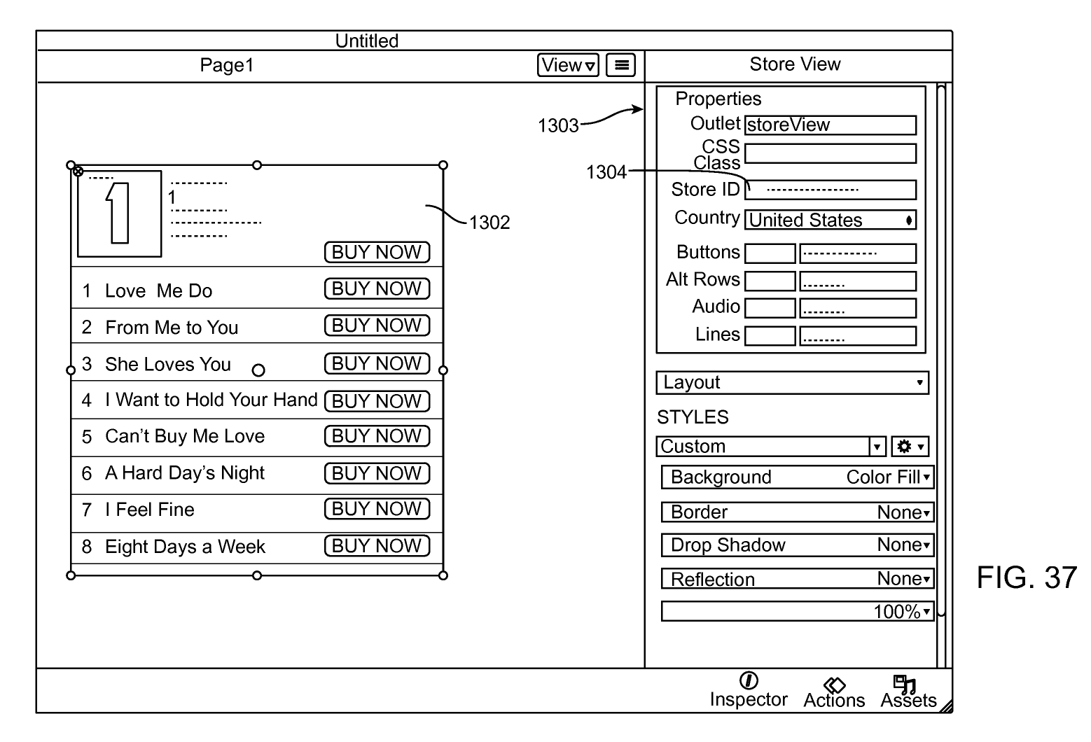

FIG. 37 illustrates a partially customized version of the template illustrated in FIG. 36. The template 1302 can be modified by dragging and dropping assets into the template as addressed above or by modifying its properties in the properties view 1303. For example, the template can be automatically completed by inserting a product ID from the online store 1304. As illustrated in FIG. 37 the product ID corresponds The Beatles “1” album, and the album art and song titles are represented in the template.

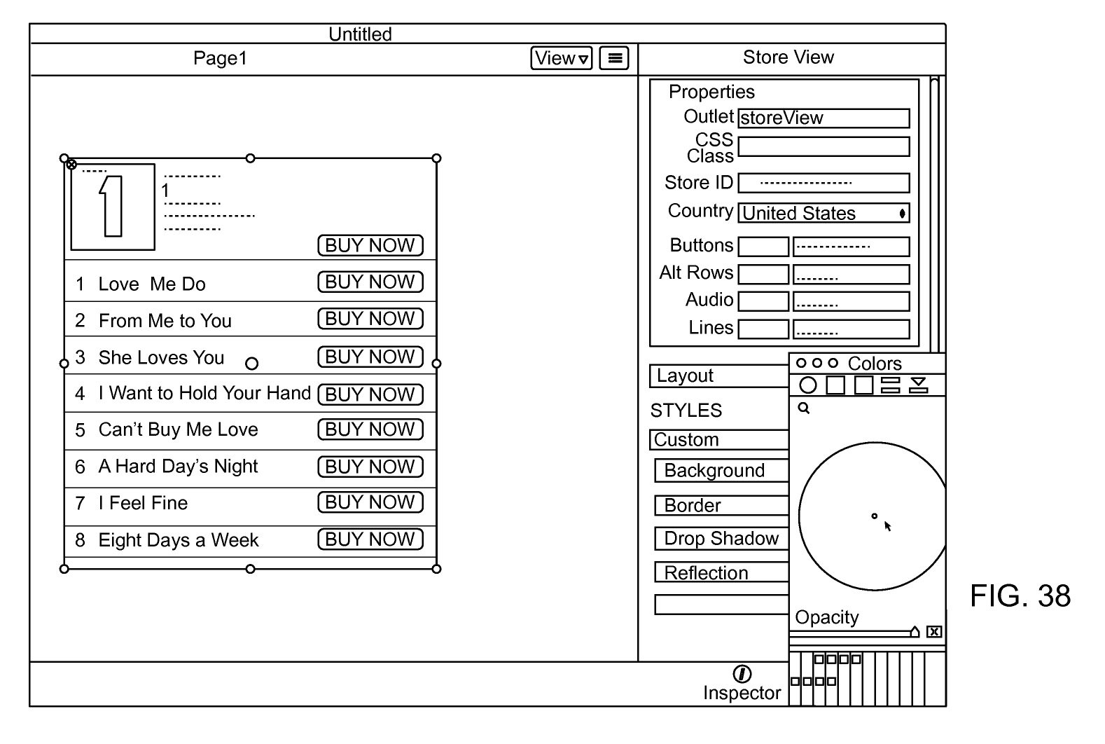

As the template is meant to be inserted into an application in which graphical appeal is important, the template can be further modified beyond just including content from an online store. The template can be further modified to take on some of the character of the application which it is inserted in. This is illustrated in FIG. 38, wherein the color of the buttons can be adjusted to match the color scheme of the primary application. In some embodiments this can be done automatically. The editing program can select a predominate color from the application and incorporate it into the template as a default.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computing system comprising:
a graphical user interface for building an animation on a page, the graphical user interface configured to accept user inputs effective associating an asset with an action, the action being scheduled to start a time point on a time axis.

2. The system of claim 1, wherein the graphical user interface is further configured to associate multiple actions with the asset.

3. The system of claim 1, wherein the graphical user interface is further configured to associate multiple actions with the asset, each of the multiple actions being scheduled to start at the same time point, thereby being grouped into an action set.

4. The system of claim 1, wherein the graphical user interface is further configured to present the action that is associated with the asset in an action menu, and further configured to initiate a preview of the animation from the action menu.

5. The system of claim 4, wherein the action menu includes a slider for navigating the time axis.

6. The system of claim 5, wherein the graphical user interface is further configured to accept user input effective to manipulate the slider along the time axis, whereby manipulating the slider is effective to control the animation such that the animation is displayed substantially as it would be at the time in time at which the slider has been manipulated to indicate.

7. The system of claim 4, wherein the graphical user interface is further configured accept a selection of the action that is associated with the asset in the action menu, and thereby to give the asset priority on the page by removing from display at least one other overlapping asset.

8. The system of claim 1 further comprising:
a processor configured to receive inputs from the graphical user interface, and to generate a set of keyframes based on the asset and at least one parameter of the action associated with the asset.

9. The system of claim 8, wherein the processor is further configured to scale the keyframes in the set of keyframes from the start time to an end time.

10. The system of claim 8, wherein the processor is further configured to split a keyframe set and insert a JavaScript code, whereby the processor can animate the asset, conduct an action defined by the JaveScript code, and complete the animation.

11. The system of claim 1, further comprising:
a processor configured to export the page, assets, and associated actions into a unit comprising a keyframe set, a JavaScript, and metadata that describes the order of execution of an animation.

12. A computer-implemented method comprising:
providing a graphical user interface for building an animation on a page;
accepting a user input into the graphical user interface, the user input effective to associate an asset with an action; and
associating the asset with the action in response to the user input, the action being scheduled to start a time point on a time axis.

13. The computer-implemented method of claim 12, wherein the associating associates multiple actions with the asset.

14. The computer-implemented method of claim 12, wherein the associating associates multiple actions with the asset, each of the multiple actions being scheduled to start at the same time point, thereby being grouped into an action set.

15. The computer-implemented method of claim 12, further comprising:
presenting the action that is associated with the asset in an action menu in the graphical user interface, and further configured to initiate a preview of the animation from the action menu.

16. The computer-implemented method of claim 15, further comprising:
providing a slider in the action menu for navigating the time axis.

17. The computer-implemented method of claim 16, further comprising:
accepting a user input effective to manipulate the slider along the time axis;
controlling the animation in response to the user input manipulating the slider such that the animation is displayed substantially as it would be at the time in time at which the slider has been manipulated to indicate.

18. The computer-implemented method of claim 15, further comprising:
accepting a selection of the action that is associated with the asset in the action menu, and
removing from display at least one other asset overlapping the asset associated with the selected action.

19. The computer-implemented method of claim 12, further comprising:
generating a set of keyframes based on the asset and at least one parameter of the action associated with the asset.

20. The computer-implemented method of claim 19, further comprising:
scaling the keyframes in the set of keyframes from the start time to an end time.

21. The computer-implemented method of claim 19, further comprising:
splitting a keyframe set and inserting a JavaScript code.

22. The computer-implemented method of claim 1, further comprising:
exporting the page, assets, and associated actions into a unit comprising a keyframe set, a JavaScript, and metadata that describes the order of execution of an animation.

23. A non-transitory computer readable medium having computer-readable instructions stored thereon for causing a computer to perform a method comprising:
providing a graphical user interface for building an animation on a page;
accepting a user input into the graphical user interface, the user input effective to associate an asset with an action; and
associating the asset with the action in response to the user input, the action being scheduled to start a time point on a time axis.
